(19) United States
(12) Patent Application Publication
(10) Pub. No.: US 2017/0200128 A1
(43) Pub. Date: Jul. 13, 2017

(54) CREATING DIGITAL EVENTS UTILIZING NATURAL LANGUAGE PROCESSING

(71) Applicant: Facebook, Inc., Menlo Park, CA (US)

(72) Inventor: John Kumahara, San Francisco, CA (US)

(21) Appl. No.: 14/990,710

(22) Filed: Jan. 7, 2016

(51) Int. Cl. G06Q 10/10; H04L 12/58; G06Q 50/00; H04L 29/08

(52) U.S. Cl. CPC G06Q 10/1095; H04L 67/10; H04L 51/046; G06Q 50/01

(57) ABSTRACT

One or more embodiments of the disclosure include systems and methods that create digital events based on text contained in one or more electronic communications. In particular, in one or more embodiments, the disclosed systems and methods utilize natural language processing techniques to detect event details from text in one or more electronic communications. Disclosed systems and methods utilize detected event details to create, modify, and send digital events.

### BACKGROUND

1. Technical Field

One or more embodiments of the present invention relate to natural language processing. More specifically, one or more embodiments of the present invention relate to systems and methods of creating digital events utilizing natural language processing.

2. Background and Relevant Art

Individuals and businesses increasingly utilize computing devices to communicate and coordinate with others. Indeed, whether through text, messaging, email, chat, social media comments, or other electronic messages, many individuals now frequently communicate with others and arrange their lives by way of personal computing devices.

As the prevalence of electronic communications increase, users seek more efficient means of communicating and coordinating with others. For example, some conventional calendaring systems enable users to create digital events (e.g., events on a digital calendar or schedule) and invite others to join the digital events (e.g., invite others to add the events to their own digital calendar or schedule). In this manner, individuals and businesses can coordinate schedules around common digital events.

Although such conventional calendaring systems enable individuals to coordinate their schedules, they still suffer from a number of shortcomings. For example, users often find conventional calendaring systems to be inefficient and poorly integrated with other applications and communication systems. Indeed, users often experience frustration in navigating a variety of applications, dialogue boxes, and other elements to add digital event details and invite others to participate. Moreover, users often find conventional systems time consuming and inconvenient because conventional systems require users to stop communicating with others, launch calendaring applications, enter information regarding digital events, invite other users to the digital events, and then return to normal activities.

Accordingly, there is much to be considered in terms of generating digital events in computing systems.

### SUMMARY

One or more embodiments described below provide benefits and/or solve one or more of the foregoing or other problems in the art with systems and methods for creating digital events utilizing natural language processing. In particular, in one or more embodiments, the disclosed systems and methods utilize natural language processing to detect event details from text utilized in one or more electronic communications. Based on the event details, the disclosed systems and methods generate digital events.

For example, one or more embodiments of the disclosed systems and methods detect event details from text in at least one electronic communication shared between a plurality of users of a communication application. Moreover, the disclosed systems and methods determine that the event details from the text in the at least one electronic communication satisfy a minimum event detail threshold. Based on the determination that the event details satisfy the minimum event detail threshold, the disclosed systems and methods present for display an indication of an event to the plurality of users. In addition, based on user interaction with the presented indication, the disclosed systems and methods create a digital event and send information regarding the created digital event to at least one of the plurality of users via the communication application.

By detecting event details from electronic communications, the disclosed systems and methods enable users to more quickly and efficiently communicate and coordinate digital events. For instance, utilizing natural language processing techniques, the disclosed systems and methods can detect event details from a plurality of electronic communications, thereby automatically and accurately populating event details with regard to a digital event. Similarly, in one or more embodiments, the disclosed systems and methods automatically send an event element (i.e., invitation) via a communication application to other users; thus, reducing the amount of time required for users to create and coordinate events with others.

Moreover, in one or more embodiments, the disclosed systems and methods further facilitate communication regarding digital events by modifying one or more users participating in a thread of electronic communications. In particular, in one or more embodiments, the disclosed systems and methods modify users participating in a thread based on detected event details. For instance, the disclosed systems and methods can add or remove users from a thread of electronic communications based on whether users are attending a digital event. In this manner, the disclosed systems and methods can facilitate communication regarding a digital event while avoiding repeated and unnecessary electronic communications to individuals that are not attending.

Similarly, in one or more embodiments the disclosed systems and methods further aid in creating digital events by identify one or more existing events corresponding to text of the electronic communications. Thus, the disclosed systems and methods can identify events (e.g., nearby events or events associated with other friends) and automatically incorporate event details from existing events into new digital events.

Additional features and advantages will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only example embodiments and are not therefore to be considered to be limiting of its scope, the methods and systems will be described and explained with additional specificity and detail through the use of the accompanying drawings.

FIG. 1A illustrates a user interface displaying a plurality of electronic communications in accordance with one or more embodiments.

FIG. 1B illustrates an event creation user interface in accordance with one or more embodiments.

FIG. 1C illustrates a user interface displaying electronic communications and an event element in accordance with one or more embodiments.

FIG. 2A illustrates a user interface displaying a plurality of electronic communications in accordance with one or more embodiments.

FIG. 2B illustrates an event modification user interface in accordance with one or more embodiments.

FIG. 2C illustrates a user interface displaying electronic communications and a modified event element in accordance with one or more embodiments.

FIG. 3A illustrates a user interface displaying a thread of electronic communications in accordance with one or more embodiments.

FIG. 3B illustrates a user interface displaying an element operable to add a participant in the thread of electronic communication in accordance with one or more embodiments.

FIG. 3C illustrates a user interface displaying a thread of electronic communications with modified participants in accordance with one or more embodiments.

FIG. 4A illustrates a user interface displaying a thread of electronic communications in accordance with one or more embodiments.

FIG. 4B illustrates a user interface displaying an element operable to remove a participant in the thread of electronic communication in accordance with one or more embodiments.

FIG. 4C illustrates a user interface displaying a thread of electronic communications with modified participants in accordance with one or more embodiments.

FIG. 5A illustrates a user interface comprising an electronic communications thread in accordance with one or more embodiments.

FIG. 5B illustrates a user interface displaying elements operable to select an existing digital event in accordance with one or more embodiments.

FIG. 5C illustrates a user interface displaying electronic communications and a digital event element in accordance with one or more embodiments.

FIG. 6 illustrates a schematic diagram of an event generation system in accordance with one or more embodiments.

FIG. 7 illustrates a schematic diagram of a network environment in which the methods and systems disclosed herein may be implemented in accordance with one or more embodiments.

FIG. 8 illustrates a flow chart of a method of generating a digital event in accordance with one or more embodiments.

FIG. 9 illustrates a block diagram of an exemplary computing device in accordance with one or more embodiments.

FIG. 10 illustrates a network environment of a social networking system according one or more embodiments.

FIG. 11 illustrates an example social graph of a social networking system in accordance with one or more embodiments.

### DETAILED DESCRIPTION

One or more embodiments of the present invention include an event generation system that analyzes text of one or more electronic communications to create digital events. In particular, in one or more embodiments, the event generation system utilizes natural language processing to identify event details and create, modify, transmit, and share digital events. Moreover, the event generation system can facilitate communication with regard to one or more digital events between participants in an electronic communication thread.

For example, in one or more embodiments, the event generation system detects event details from text in at least one electronic communication shared between a plurality of users of a communication application. The event generation system determines that the event details from the text in the at least one electronic communication satisfy a minimum event detail threshold. Based on the determination that the event details satisfy the minimum event detail threshold, the event generation system presents for display an indication of an event to the plurality of users. Moreover, based on user interaction with the presented indication, the event generation system creates a digital event and sends information regarding the created digital event to at least one of the plurality of users via the communication application.

By utilizing natural language processing to analyze text of one or more communications, the event generation system can create and coordinate events amongst a plurality of users quickly and efficiently. For instance, the event generation system can automatically populate event details (e.g., time, location, attendees, etc.) in a digital event based on text detected in one or more electronic communications. Similarly, the event generation system can automatically modify event details based on text in one or more electronic communications.

The event generation system can create digital events based on multiple electronic communications from multiple users. For example, the event generation system can detect event details from a first electronic communication sent from a first user, detect additional event details from a second electronic communication from a second user, and detect more event details from a third electronic communication from a third user. The event generation system can create a digital event that combines the event details from the plurality of electronic communications from the plurality of users.

In one or more embodiments, the event generation system utilizes natural language processing techniques to detect event details and create a digital event. For example, in one or more embodiments, the event generation system utilizes machine learning techniques to identify usage patterns that indicate event details. In particular, the event generation system can utilize machine learning natural language processing to generate a trained natural language processing algorithm. Moreover, the event generation system can identify combinations of characters (e.g., nouns and verbs) that indicate particular event details.

In addition to natural language process, the event generation system can also utilize existing digital events to identify event details. For example, in one or more embodiments, the event generation system accesses digital events created by users of a social networking system. The event generation system can create a digital event for a user based on existing digital events created by users of the social networking system and event details detected from text of one or more electronic communications. Thus, for example, the event generation system can detect event details from text of one or more electronic communications, identify a correspondence between the event details and an existing digital event, and suggest a digital event based on both the text of the one or more electronic communications and the existing digital event.

As mentioned previously, in one or more embodiments, the event generation system applies a minimum event detail threshold. In particular, in one or more embodiments, the event generation system will suggest creation of a digital event upon determining that a minimum event detail threshold has been satisfied. For example, in one or more embodiments, the event generation system will only provide an indication of an event upon detecting event details and determining that the event details (e.g., the number, type, or certainty of the event details) satisfy the minimum event detail threshold. Thus, in at least one example embodiment, the event generation system will wait until detecting at least three (or some other predetermined number of) event details (at a particular certainty level) before surfacing a suggestion (or indication) to create a digital event.

The event generation system can utilize one or more threshold values. For example, in addition to utilizing a minimum event detail threshold prior to providing an indication of an event suggesting, the event generation system can also utilize a supplemental event detail threshold. For instance, in one or more embodiments, the event generation system will automatically generate a digital event upon detecting satisfaction of a supplemental event detail threshold. In particular, in at least one embodiment, the event generation system automatically generates a digital event upon detecting four event details (at a heightened certainty level).

In one or more embodiments, the event generation system also creates digital events by analyzing the times of one or more electronic communications. For instance, the event generation system can determine that a period of time between electronic communications indicates that the electronic communications no longer relate to the same event (e.g., electronic messages in January regarding an event may not relate to electronic messages in June regarding an event). Accordingly, in one or more embodiments, the event generation system applies a time window in detecting event details from electronic messages. Specifically, the event generation system can apply a time window to limit the scope of electronic messages (e.g. text) analyzed in detecting event details and creating digital events.

The event generation system can apply one or more time windows based on a variety of factors. For instance, the event generation system can utilize a time window based on one or more characteristics of an electronic communication (e.g., a time of the electronic communication, a date of the electronic communication, an amount of time between the electronic communication and another electronic communication). Similarly, the event generation system can apply different time windows based on a particular day (e.g., apply a first time window on the weekend and a second time window during the week). The event generation system can apply a time window based on frequency of contact between participants (e.g., apply a first time window for friends that communicate hourly and a second time window for acquaintances that communicate once a month). Similarly, the event generation system can apply a time window based on a cluster of electronic communications (e.g., by applying a clustering algorithm to determine clusters of electronic communications). In yet other embodiments, the event generation system can apply a time window based on characteristics of an event (e.g., apply a first time window for a long-planned event such as a family reunion and a second time window for a quickly-planned event such as a happy-hour meeting).

Upon detecting event details and/or determining that event details satisfy one or more thresholds, the event generation system can create a digital event. For example, in one or more embodiments, the event generation system presents an indication (or suggestion) of an event to a user. Upon user interaction with the indication, the event generation system presents an event user interface for display and populates event details for review and confirmation by the user. The event generation system creates a digital event based on the detected event details and/or additional user input.

In addition to creating a digital event based on text of one or more electronic communications, the event generation system can also modify one or more digital events. For example, after creating a digital event, the event generation system can detect text indicating a modification to event details applicable to the digital event. In response, the event generation system can modify the digital event to include the modified event details.

Furthermore, in one or more embodiments, the event generation system also facilitates communication regarding digital events. Indeed, in one or more embodiments, upon creating (or modifying) a digital event, the event generation system provides a digital event element to one or more users. For example, with regard to users participating in a thread of electronic communications (e.g., a group text message), the event generation system can automatically generate a message containing a digital event element (e.g., an element that includes the event details). Similarly, the event generation system can also generate a digital event element (i.e., an invitation or notification) and send the digital event element to another user via a social network system (e.g., via a social network application configured to communicate with a social networking server).

Moreover, the event generation system can also facilitate communication regarding digital events by modifying participants in electronic communications regarding the digital event. For example, in one or more embodiments, the event generation system can compare users participating in a group message to individuals participating (or invited to) a digital event and modify the users participating in the group message based on the comparison. For instance, the event generation system can determine that a first individual invited to a digital event is not participating in the group message and add the first individual to the group message. Alternatively, the event generation system can determine that a second individual participating in the group message is not included in the digital event and remove the second individual from the group message. In this manner, the event generation system enables communication regarding digital events while avoiding bothersome communications to individuals not participating in the corresponding events.

To permit users to easily and quickly create digital events and electronic communications regarding digital events, the event generation system can operate seamlessly (i.e., with limited or no user input) across numerous applications. Indeed, the electronic communication system can implicitly (i.e., without users being aware that they are opening or closing separate applications) utilize a communication application, a social media application, a calendaring application and/or other applications to facilitate creating and communication regarding digital events.

As used herein, the term “event” refers to a thing that happens or takes place. In particular, the term “event” includes a planned social occasion. For example, the term “event” includes a party, gathering, activity, performance, game, presentation, meeting, or other occasion.

As used herein, the term “event details” refers to characteristics of an event. In particular, “event details” include characteristics relating to date, time, duration, location, participants, activities, schedules, performers, attendees, assignments, or organizers of an event. Thus, for example, event details related to a sporting event for a group of friends may include starting time, date, teams, venue, friends attending, food assignments, meeting place, seats, tickets, etc.

As used herein, the term “digital event” refers to a digital item that reflects event details. In particular, the term “digital event” includes a digital calendaring item that comprises event details. For example, the term “digital event” includes digital files with the following extensions: .ics, .ical, .ifb, .icalendar, .csv, or .txt. Regardless of file type, the term “digital event” includes any digital item that reflects event details, including event details stored on a social network, client device, server, or database.

As used herein, the term “electronic communication” refers to any digital item that conveys information between users. In particular, the term “electronic communication” includes digital items conveying text from one user to another. For example, “electronic communication” includes an e-mail message, chat message, text message, SMS message, instant message, social media message, or social media comment.

As used herein the term “application” refers to a set of computer instructions that, when executed by a processor associated with a computing device, causes the computer to perform a task. The term application can include a set of instructions in any form, including a program, library function, plug-in, script, or “app” for a mobile device. Moreover, applications can cause a computer to perform any number of tasks, including, creating digital events, analyzing text in electronic communications, accessing a social network, and/or receiving and sending electronic communications.

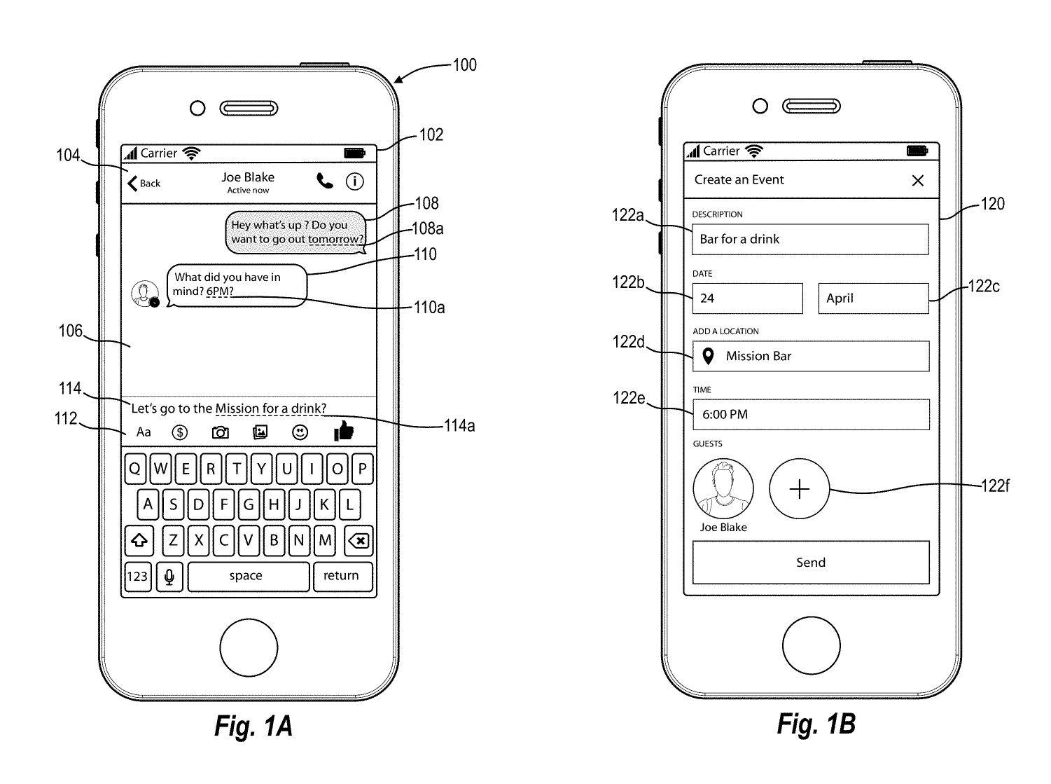

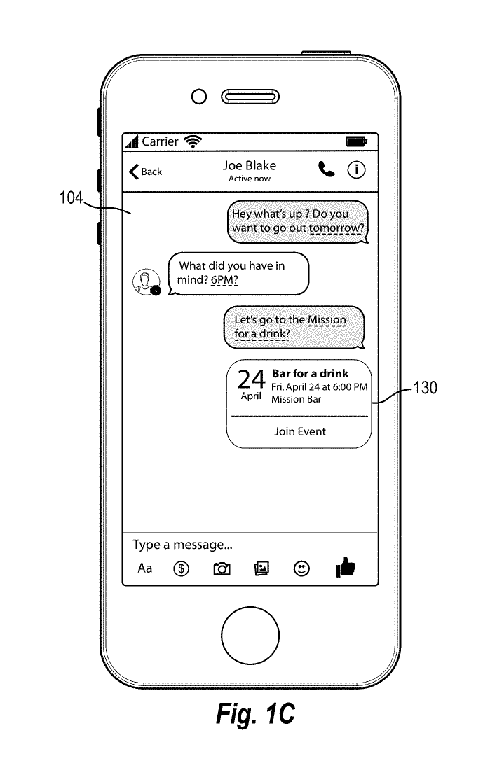

Turning now to FIGS. 1A-1C, additional detail will be provided regarding creating one or more events utilizing the event generation system. In particular, FIG. 1A illustrates a computing device 100 having a display screen 102 showing a communication user interface 104. The communication user interface 104 facilitates the creation and display of electronic communications. In particular, the communication user interface 104 facilitates the display of electronic communications sent and/or received by a user of the computing device 100 and one or more other users. In particular, the communication user interface 104 can display a thread of electronic communications in a communication display area 106.

As illustrated in FIG. 1A, the communication user interface 104 displays a thread of electronic communications in the communication display area 106 between the user of the computing device 100 and another user (i.e., “Joe Blake”). Specifically, the communication display area 106 includes a first electronic communication 108 (“Hey what's up? Do you want to go out tomorrow?”) and a second electronic communication 110 (“What did you have in mind? 6 PM?”).

The communication user interface 104 also includes a message input area 112. The message input area 112 facilitates creation of one or more electronic communications. Indeed, as illustrated in FIG. 1A, the user of the computing device 100 has provided text (“Let's go to the Mission for a drink”) in the message input area 112 comprising a draft electronic communication 114 to another user (i.e., “Joe Blake”).

As mentioned previously, in one or more embodiments, the event generation system analyzes the text of one or more electronic communications and detects event details. Thus, with regard to the embodiment illustrated in FIG. 1A, the event generation system analyzes the text of electronic communications 108, 110, 114 and detects one or more event details.

The event generation system can utilize a variety of approaches in analyzing text to identify event details. For instance, as mentioned previously, in one or more embodiments, the event generation system utilizes natural language processing techniques to identify event details. More particularly, in one or more embodiments, the event generation system utilizes natural language processing techniques to identify words (e.g., nouns, adjectives, verbs, etc.) corresponding to one or more event details.

For example, in one or more embodiments, the event generation system utilizes machine-learning natural language processing techniques to identify event details. Specifically, the event generation system trains a natural language processing algorithm utilizing a corpus of electronic communications, wherein the electronic communications comprise text regarding known events. Specifically, the event generation system trains the natural language processing algorithm by providing text of one or more electronic communications to the natural language processing algorithm with known event details regarding the known events. The natural language processing algorithm predicts event details from the provided text and compares the prediction to the known event details. By repeatedly predicting event details based on one or more electronic communications and comparing the prediction to known event details, the natural language processing algorithm can learn to more accurately predict and identify event details when provided with one or more electronic communications.

In one or more embodiments, the event generation system utilizes a trained natural language processing algorithm to identify event details. In particular, in one or more embodiments, the event generation system provides text from one or more electronic communications to the trained natural language processing algorithm and the trained natural language processing algorithm identifies one or more event details corresponding to the one or more electronic communications.

In particular, in one or more embodiments, the trained natural language processing algorithm predicts an event detail corresponding to text of one or more electronic communications, wherein the prediction comprises a certainty score. For example, the trained natural language processing algorithm can create a certainty score reflecting the likelihood that particular text (e.g., “Do you want to go out tomorrow”) corresponds to an event detail for a particular event. In general, the certainty score increases as the likelihood that particular text corresponds to an event detail. For example, in one or more embodiments, the certainty score reflects a percentage that text accurately corresponds to an event detail. As discussed in greater detail below, the event generation system can utilize the certainty score to create a digital event.

In one or more embodiments, the event generation system utilizes a natural language processing algorithm to generate a database of triggering language data and/or rules. Specifically, in one or more embodiments, the event generation system generates a database of character combinations (e.g., nouns, verbs, adjectives, etc.) indicative of one or more event details. For instance, the event generation system can utilize a natural language processing algorithm to generate a database indicating that the combination of characters “works for me” indicates assent by an individual to a proposal, such as a proposed event. Similarly, the event generation system can generate a database indicating that “how about,” followed by a numeric character is indicative of a proposal for a meeting time. Furthermore, the event generation system can generate a database indicating that a particular verb (e.g., “meet”) in the vicinity (e.g., within two words) of a location (e.g., “home”) is indicative of a meeting place.

The event generation system can utilize a variety of machine learning algorithms to develop a trained natural language processing algorithm. For example, the event generation system utilizes decision tree algorithms, ensemble algorithms, k-NN algorithms, linear regression, neural networks, or other machine learning algorithms.

In addition to a machine learning natural language processing algorithm, in alternative embodiments, the event selection system can utilize other algorithms or processes to identify event details. For instance, in one or more embodiments, the event generation system constructs a plurality of rules to identify event details. For example, the event generation system can construct a rule that any time the words “tomorrow” or “yesterday” are utilized, that the text corresponds to an event detail. Similarly, the event generation system can construct a rule that any time a date appears in an electronic communication, that the date corresponds to an event detail.

Moreover, in one or more embodiments, the event generation system also considers one or more times associated with electronic communications in detecting event details. For example, in one or more embodiments, the event generation system trains a natural language processing algorithm with electronic communications that include time information (e.g., at timestamp for each electronic communication). In this manner, the natural language processing algorithm learns to identify electronic communications containing event details based on time. For example, the event generation system can train the natural language processing algorithm to distinguish between electronic communications discussing event details applicable to an old event and more recent electronic communications discussing event details applicable to a current event.

In other embodiments, the event generation system considers times associated with one or more electronic communications by utilizing one or more time windows. In particular, the event generation system limits analysis to text from electronic communications falling within the one or more time windows. For example, in one or more embodiments, the event generation system utilizes a 24-hour time window and limits its analysis to text that falls within a 24-hour time window (e.g., 24 hours from the most recent time or from the most recent electronic communication).

The event generation system can select one or more windows based on a variety of factors. For example, in one or more embodiments, the event generation system selects a time window based on the current date or time. For instance, the event generation system can apply a first time window at a first time (e.g., apply a relatively long time window at 12:00 on a workday when users tend to plan events less frequently or further in the future) and apply a second time window to communications at a second time (e.g., apply a relatively short window on a Saturday afternoon when users tend to plan events more frequently and in the immediate future).

Similarly, the event generation system can select a time window based on characteristics of one or more electronic communications. For example, the event generation system can select a time window based on the time and/or date of an electronic communication (e.g., an electronic communication received on a weekend). Moreover, the event generation system can select a time window based on a time between electronic communications.

In addition, in one or more embodiments, the event generation system selects a time window based on characteristics of a particular event (e.g., type, timing, location, etc.). For instance, the event generation system can detect an event detail from a first thread of electronic communications indicating that a user intends to plan a family reunion in six months. Similarly, the event generation system can detect an event detail from a second thread of electronic communications indicating that a user intends to attend a dinner the next day. The event generation system can apply a longer time window with regard to the family reunion and a shorter time window with regard to the dinner.

Moreover, in one or more embodiments, the event generation system selects a time window based on frequency of electronic communications. In particular, the event generation can detect the frequency of electronic communications in a thread of electronic communications and establish a time window based on the frequency (e.g., average frequency of electronic communications). For example, the event generation system can determine that a user sends and/or receives electronic communications with regard to a friend nearly every day. Similarly the event generation system can determine that a user sends and/or receives electronic communications with regard to a relative nearly once a month. The event generation system can utilize a shorter time window for the friend and a longer time window for the relative.

In addition, in one or more embodiments, the event generation system selects a time window based on user history. For example, the event generation system can detect that a user arranges events at particular times with particular individuals or groups. The event generation system can detect and analyze user history and identify a time window based on detected user history.

Furthermore, in one or more embodiments, the event generation system can identify clusters of electronic communications based on time and determine an applicable time window from the clusters. For example, in one or more embodiments, the event generation system applies one or more clustering algorithms to determine an applicable time window. In particular, in one or more embodiments, the event generation system applies k-means clustering to a plurality of electronic communications to identify a relevant time window. The event generation system can also apply hierarchical clustering, expectation maximized clustering, balanced iterative reducing and clustering using hierarchies, or other clustering algorithms.

The event generation system can utilize identified clusters to identify a time window. For instance, in one or more embodiments, the event generation system identifies the most recent cluster of electronic communications as the time window. In other embodiments, the event generation system identifies a time window by starting at the most recent cluster and adding clusters separated by less then a particular duration of time (e.g., clusters within 15 minutes from the most recent cluster and within 15 minutes of any other added cluster). Similarly, in one or more embodiments, the event generation system analyzes all clusters that fall within a particular time range, where the particular time range is based on the size of one or more clusters (e.g., clusters within 10% of the time of the most recent cluster).

Returning to FIG. 1A, utilizing the techniques just discussed, the event generation system analyzes the text of the electronic communications 108, 110, 114 and identifies a plurality of event details. In particular, the event generation system identifies a date from the first electronic communication 108 (i.e., tomorrow), a time from the second electronic communication 110 (i.e., 6:00 p.m.), a location from electronic communication 114 (i.e., the Mission Bar), and a description/purpose from electronic communication 114 (i.e., “for a drink”). Moreover, the event generation system identifies a participant (e.g., Joe Blake), based on the second electronic message 110 and/or the participants of the messaging thread.

As mentioned previously, in one or more embodiments, the event generation system provides an indication of one or more events. In particular, as illustrated in FIG. 1A, the event generation system provides a first indication 108a, a second indication 110a, and a third indication 114a. The indications 108a, 110a, and 114a signal that a user can create a digital event based on one or more detected event details.

In one or more embodiments, the event generation system compares detected event details to one or more thresholds before providing an indication of an event. In particular, in one or more embodiments, the event generation system compares detected event details with a minimum event detail threshold. Thus, with regard to the embodiment of FIG. 1A, the event generation system compares the detected event details with a minimum event detail threshold before providing the indications 108a, 110a, and 114a for display to the user via the communication user interface 104.

The event generation system can apply a variety of minimum event detail thresholds. For instance, with regard to FIG. 1A, the event generation system applies a minimum event detail threshold that requires at least four event details before providing the indications 108a, 110a, or 114a. For example, before entry of the electronic communication 114 the event generation system had only detected three event details (i.e., a date, “tomorrow,” a time, “6 PM,” and a participant, “Joe Blake”). Accordingly before entry of the electronic communication 114 the event generation system determined that the detected event details failed to satisfy the minimum event detail threshold and did not provide any of the indications 108a, 110a, or 114a. After entry of the electronic communication 114, the event generation system detects a fourth event detail (i.e., a location, the “Mission”), determines that the detected event details satisfy the minimum event detail threshold, and provide the indications 108a, 110a, and 114a.

Although the embodiment of FIG. 1A utilizes a minimum event detail threshold of four event details, the minimum event detail threshold can comprise any number of details. For instance, in one or more embodiments, the minimum event detail threshold requires only two or three event details. In other embodiments, the minimum event detail threshold requires five event details before surfacing an indication of a suggested (or available) event.

In one or more embodiments, the event generation system selects a number of events details to apply with regard to a minimum event detail threshold. The event generation system can select a number of event details based on a variety of factors. For instance, the event generation system can select a number of event details to apply based on characteristics of an event such as a type of event (e.g., a sensitive or significant event such as a funeral or a meeting with an ex girlfriend may require more event details than a date with friends), a timing of an event (e.g., an event further in the future may require more event details than an event occurring later in the day), or a location of an event (e.g., an event in a different state or country may require additional details than an event in the same vicinity). Similarly, the event generation system can select a number of event details based on characteristics of one or more electronic communications (e.g., a particular time or date of electronic communications, such as a Friday night, may require fewer event details).

Moreover, the event generation system can select a number of event details to apply based on the number of digital events previously indicated to a user (e.g., require a greater number of event details if numerous events have previously been suggested but not utilized). Similarly, the event generation system can select a number of event details to apply based on the number of digital events previously created by a user (e.g., require a fewer number of event details if a user frequently creates digital events from indications). In addition, the event generation system can select a number of event details to apply based on a time since last suggesting an event, a time since last creating a digital event, characteristics of a computing device, demographic information of a user (e.g., age), user input, or other factors.

Moreover, aside from a particular number of event details, the minimum event detail threshold can comprise other characteristics. For instance, the minimum event detail threshold can comprise a threshold with regard to the quality (e.g., confidence) of an event detail. For example, as mentioned above, in one or more embodiments the event generation system utilizes a natural language processing algorithm to generate a certainty score with regard to one or more event details. The event generation system can apply a minimum event detail threshold that comprises a minimum certainty score (e.g., a minimum likelihood that the event generation system has accurately identified an event detail), before providing an indication of an event. For example, in one or more embodiments, the event generation system requires at least four event details, each with a certainty score above 50%, before surfacing an indication or suggestion with regard to an event.

As mentioned previously, however, upon determining that detected event details satisfy one or more minimum event detail thresholds, the event generation system can provide one or more indications or suggestions of an available event. Moreover, in one or more embodiments, upon user interaction with the one or more indications, the event generation system can create a digital event. For example, with regard to FIG. 1A, the event generation system provides the indications 108a, 110a, and 114a for display. As illustrated in FIG. 1B, upon user interaction with the indications 108a, 110a, or 114a, the event generation system provides an event creation user interface 120.

Although the embodiment if FIG. 1B presents the event creation user interface 120 upon user interaction with one of the indications 108a, 110a, or 114a, it will be appreciated that the event generation system can also generate a digital event (or present the event creation user interface 120) without user interaction with the indications 108a, 110a, and 114a. In particular, in one or more embodiments, the event generation system automatically creates a digital event (or automatically presents the event creation user interface 120).

For example, in one or more embodiments, the event generation system automatically creates a digital event (or presents the event creation user interface 120) based on a supplemental event detail threshold (e.g., a threshold that is more stringent than the minimum event detail threshold). For example, in one or more embodiments, the event generation system selects a supplemental event detail threshold that requires additional event details or a higher certainty score than a minimum event detail threshold.

Specifically, in one or more embodiments, the event generation system utilizes a supplemental event detail threshold that requires five event details with a certainty score greater than 80%. Upon detecting satisfaction of the supplemental event detail threshold, the event generation system can automatically create a digital event (or automatically present the event creation user interface 120).

Similar to the minimum event detail threshold, the event generation system can select a supplemental event detail threshold based on a variety of factors. For instance, the event generation system can select a supplemental event detail threshold based on characteristics of event details or an event, based on characteristics of an electronic communication, based on a number of events suggested (or indicated), based on a number of digital events created, based on a time since suggesting an event, based on a time since creating a digital event, based on user characteristics, based on device characteristics, based on user input, or some other factor.

Once the event generation system determines that it has satisfied any applicable threshold to presenting an event creation user interface, it can present event details to a user and create a digital event. For example, as shown in FIG. 1B, the event creation user interface 120 contains a variety of event detail elements 122a-122f The event detail elements 122a-122f facilitate creation of a digital event (e.g., selection, modification, or entry of event details). As shown, the event generation system automatically populates the event detail elements 122a-122f based on detected event details. In particular, the event generation system populates the description event detail element 122a based on event details detected from the electronic communication 114, populates the date event detail elements 122b-122c based on event details detected from electronic communication 108, populates the location event detail element 122d based on the electronic communication 114, and populates the time event detail element 122e based on the second electronic communication 110. Moreover, based on the second electronic communication 110 (i.e., a message from Joe Blake proposing a time), the event generation system populates the guest event detail element 122f.

Although FIG. 1B shows event detail elements 122a-122f, it will be appreciated that the event generation system can provide additional or fewer event detail elements (and detect and/or generate additional event details). For example, as discussed above, the event generation system can detect and provide for display event details including, start time, end time, presenters, organizers, performers, schedules, tickets, attachments, assignments, access codes (e.g., a gate code to enter a community or a password to enter an online forum), etc.

In addition to presenting event details for display, the event creation user interface 120 can also receive user input of event details or receive user input of modifications to event details. For instance, based on user input, the event creation user interface 120 can receive a modification to the description (e.g., change “Bar for a drink” to “Mission for a drink”). Similarly, the event creation user interface 120 can receive identification of additional guests via user interaction with the guest event detail element 122f.

Although FIG. 1B illustrates displaying event details detected from one or more electronic communications, as mentioned previously, the event generation system can also detect and provide event details from other sources. For instance, in one or more embodiments, the event generation system identifies event details from existing digital events. In particular, in one or more embodiments, the event generation system identifies event details from existing digital events created by users of a social networking system. For example, one or more users of a social networking system can create a first digital event indicating that a musician will provide live music at the Mission Bar on April 24 from 7:00 to 8:00 p.m. The event generation system can provide an additional event detail in the event creation user interface 120 (e.g., that a musician will provide live music from 7:00 to 8:00 p.m.) based on the event detail detected from the first digital event.

The event generation system can detect and provide any type or variety of event details from existing digital events. Indeed, the event generation system can provide event details with regard to attendees, location, time, schedule, performers, or other event details from an existing digital event. Thus, by way of additional example, if a first digital event was created by a first user of a social networking system (e.g., indicating that the first user is attending the Mission Bar to listen to live music), the event generation system can add an event detail to the event creation user interface 120 indicating that the first user (e.g., a friend of the user of the computing device 100) is attending the event.

In addition to existing digital events, the event generation system can detect and provide event details from a variety of other sources. For instance, the event generation system can identify event details from a third-party server accessible via the Internet. For example, the event generation system can detect from a website that the Mission Bar closes at 10:00 on April 24. Based on the information detected from the website, the event generation system can provide additional event details to the user of the computing device 100 (e.g., display a closing time for the Mission Bar via the event creation user interface 120). The event generation system can provide any type or variety of event details from third-party servers (e.g., contact information, address, hours of operation, performers, etc.).

As mentioned previously, the event generation system can also create a digital event. Indeed, upon detecting and providing event details for display, in one or more embodiments, the event generation system creates and stores a digital event. For example, as shown in FIG. 1B, the event creation user interface 120 includes a send element 124. Upon user interaction with the send element 124, the event generation system creates and stores a digital event. The event generation system can store the digital event on the computing device 100 and/or a remote server.

As mentioned previously, in one or more embodiments, the event generation system can seamlessly transition between applications on a computing device in creating digital events. In particular, in one or more embodiments, the event generation system utilizes a separate application, such as a calendaring application, a scheduling application, or a social media application to create a digital event. For example, with regard to the embodiment of FIGS. 1A-1B, the event generation system utilizes a communication application (i.e., a communication application that generates the communication user interface 104) to send and receive electronic communications, and detect event details from the electronic communications. However, the event generation system utilizes a social media application (i.e., a social media application that generates the event creation user interface 120), to display event details, receive event details, and ultimately generate a digital event.

Thus, for example, in one or more embodiments, the event generation system utilizes a social media application (or some other application) to communicate with a remote server to create and store a digital event. In particular, with regard to FIG. 1B, the event generation system utilizes a social media application to communicate with a social networking system on a remote server to create and store a digital event with the social networking system. The social network system can then utilize the digital event. For example, the social networking system can send notifications to the computing device 100 regarding the digital event (e.g., reminders or updates regarding modifications to the digital event). Similarly, the social network system can utilize the digital event to inform other users regarding the digital event (e.g., inform friends of the user of the computing device 100 regarding the user's schedule, provide event details to others planning a corresponding event, etc.).

Although the embodiment of FIG. 1B utilizes a separate social media application to create and send a digital event to a remote server, it will be appreciated that other embodiments of the event generation system do not utilize a separate application to create a digital event. Indeed, in one or more embodiments, the event generation system utilizes a single application (e.g., a communication application) to detect event details and create a digital event. Similarly, as mentioned above, although the embodiment of FIG. 1B communicates and stores a digital event with a social networking system on a remote server, the event generation system can also create and store a digital event locally on the computing device 100.

The event generation system can also seamlessly transition from a second application (e.g., a social media application, calendaring application, or other application) back to a first application (e.g., a communication application) and/or utilize a second application in the background while presenting a first application. Indeed, as illustrated in FIG. 1C, upon user interaction with the send element 124, the event generation system transitions back to the communication application and the communication user interface 104. Specifically, the event generation system presents the communication user interface 104.

Moreover, in one or more embodiments, based on user interaction with the send element 124, the event generation system presents and sends an event element 130. In particular, the event generation system presents the event element 130 to the user of the computing device 100 and sends the event element 130 to other users participating in the thread of electronic communications (e.g., Joe Blake). As illustrated in FIG. 1C, the event element 130 displays many of the event details detected and presented with regard to FIG. 1B. Moreover, the event element 130 enables a user to receive or provide additional information regarding a corresponding digital event. In particular, upon user interaction with the event element 130, a recipient can see additional event details corresponding to the digital event, join the digital event, decline participation in the digital event, and/or modify the digital event.

Notably, the event element 130 is sent as an electronic communication between participants. Thus, as illustrated in FIG. 1C, the event element 130 is sent as a message in a group message between a plurality of users. Thus, the event generation system enables users to communicate regarding an event, generate a digital event, and invite others to a digital event with minimal user interaction. Indeed, by simply engaging in normal electronic communications (as shown in FIG. 1A) in a communication application, users can seamlessly generate a digital event, send an event element, and communicate regarding the digital event in-line with minimal user input.

In addition, although FIG. 1C illustrates the event element 130 sent via a messaging communication, the event generation system can also send an event element via other delivery mechanisms. For example, in one or more embodiments, the event generation system sends the event element 130 to another user (i.e., a participant in a thread of electronic communications) via a social media application. In particular, in one or more embodiments, the event generation system sends an event element (or some other request or call) to a social networking system and the social networking system sends the event element 130 (or some other invitation or notification) to another user of the social networking system. Thus, in one or more embodiments, the event generation system can send information regarding a digital event both by a messaging application and via a social networking system.

As discussed previously, in one or more embodiments, the event generation system can automatically generate a digital event (i.e., without user input) upon detecting satisfaction of one or more supplement event detail thresholds. Similarly, the event generation system can automatically prepare an event element based on satisfaction of one or more supplemental event detail thresholds. For example, in one or more embodiments, rather than display the event creation user interface 120, the event generation system prepares and sends the event element 130 upon satisfying a supplemental event detail threshold. In other embodiments, the event generation system automatically initiates a prompt asking the user if they would like to send the event element 130 upon satisfaction of the supplemental event detail threshold.

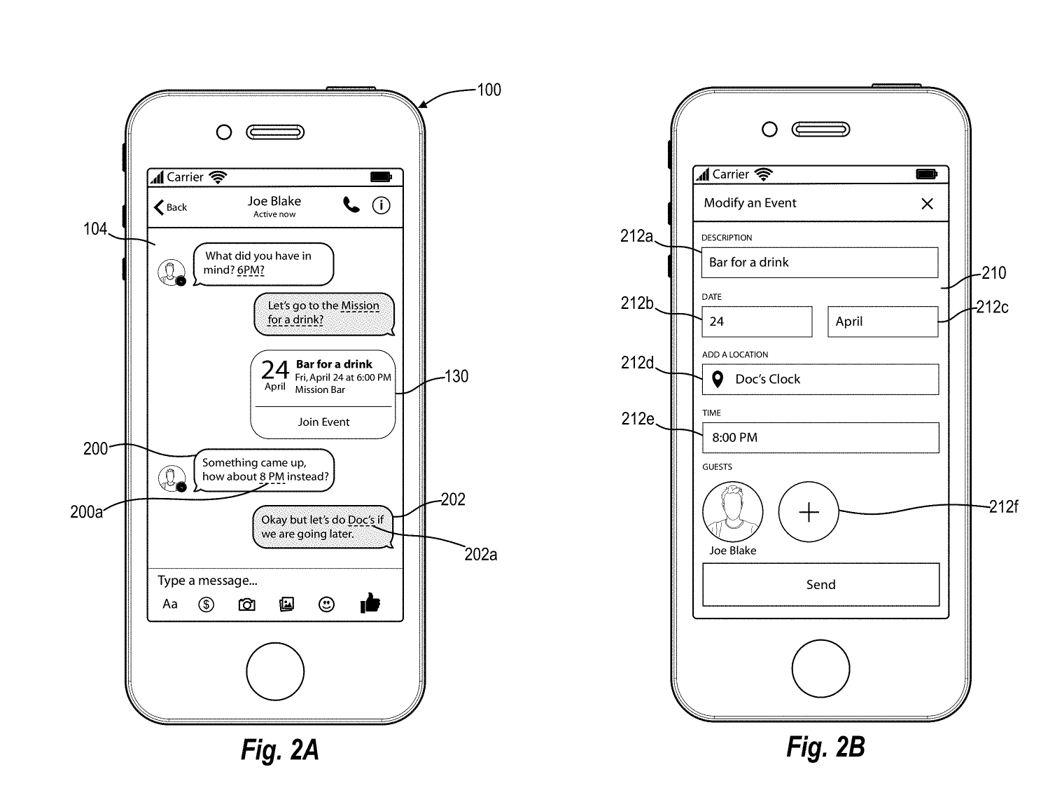

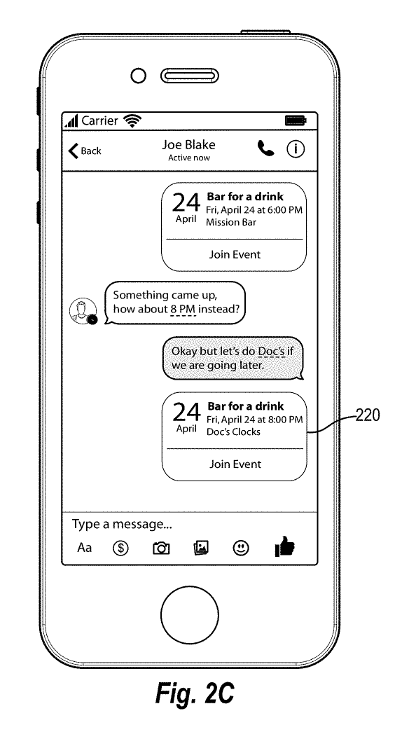

As mentioned previously, in addition to creating a digital event, the event generation system can also modify digital events. In particular, the event generation system can modify digital events based on text in one or more electronic communications. For example, FIGS. 2A-2C illustrate modifying a digital event in accordance with one or more embodiments of the event generation system.

In particular, FIG. 2A illustrates the computing device 100 and the communication user interface 104 displaying a thread of electronic communications, including the event element 130. After the user of the computing device 100 sends the event element 130, another user (i.e., Joe Blake) sends an electronic communication 200 (i.e., “Something came up, how about 8 PM instead”). Moreover, the user of the computing device 100 sends another electronic communication 202 (i.e., “Okay, but let's do Doc's if we are going later.”).

The event generation system can detect modified event details from the text of one or more electronic communications. Moreover, the event generation system can modify a digital event based on the modified event details. For example, as shown in FIG. 2A, the event generation system detects a modified event detail from the electronic communication 200 (i.e., a modified start time of “8 PM”) and detects another modified event detail from the electronic communication 202 (i.e., a modified location of “Doc's”).

Upon detecting modified event details (and/or satisfaction of one or more modification event detail thresholds), in one or more embodiments, the event generation system provides an indication of available modifications to a digital event. For instance, as shown in FIG. 2A, the event generation system provides indications 200a and 202a for display via the communication user interface 104.

Moreover, upon user interaction with one or more provided indications, the event generation system provides an event modification user interface. For example, as shown in FIG. 2B, based on user interaction with the indications 200a or 202a (e.g., a touch event on an area of the display screen 102 corresponding to the indication 200a), the event generation system provides an event modification user interface 210. Specifically, the event modification user interface 210 comprises event detail elements 212a-212f (i.e., event detail elements corresponding to the event detail elements 122a-122f). Notably, however, the event generation system populates the location event detail element 212d with a modified event detail (i.e., “Doc's Clock”) based on the electronic communication 200 and populates the time event detail element 212e with a modified event detail (i.e., “8:00 PM) based on the electronic communication 202. In this manner, the event generation system can populate fields with modified event details detected from one or more electronic communications.

As described above with regard to the event creation user interface 120, the event generation system can receive revisions to event details via the event modification user interface 210 (e.g., the user of the computing device 100 can modify the description, date, location, etc.). Moreover, upon user interaction with a send element 214, the event generation system can create a modified digital event and/or send a modified event element to one or more users. Indeed, as illustrated in FIG. 2C, upon user interaction with the send element 214, the event generation system creates and sends a modified event element 220 to another user (i.e., Joe Blake).

Although FIGS. 2A-2C illustrate modifying a digital event based on text of one or more electronic communications, it will be appreciated that the event generation system can modify digital events based on a variety of other factors. For example, as discussed above, in one or more embodiments, the event generation system generates event details based on existing digital events (e.g., digital events created by users of a social networking system). Accordingly, in one or more embodiments, the event generation system also modifies digital events based on modifications to other existing digital events.

In particular, as described above, in one or more embodiments, the event generation system identifies a correspondence between an existing digital event and a new digital event. The event generation system can detect modifications to the existing digital event and modify the new digital event based on the modifications to the existing digital event. For example, consider a first user of a social networking system that creates a first digital event for a music concert, and a second user of the social networking system that creates a second digital event for the music concert. The event generation system can determine a correspondence between the first digital event and the second digital event (and, for example, can recommend event details to the second user in creating the second digital event based on the first digital event). The event generation system can detect modifications to the first digital event (e.g., a change in start time) and can modify the second digital event based on the detected modifications to the first digital event (e.g., notify the second user of the change in start time and suggest a modification to the second digital event).

Similarly, the event generation system can detect modifications to a digital event from a third-party server, such as a website. Thus, for example, if a location for an event becomes unavailable and the information is shared via a remote server (e.g., “Doc's Clocks” closes for repairs and posts the closure on its website) the event generation system can detect the change and modify a corresponding digital event (e.g., notify a user of the closure and suggest modification to a location event detail in a digital event).

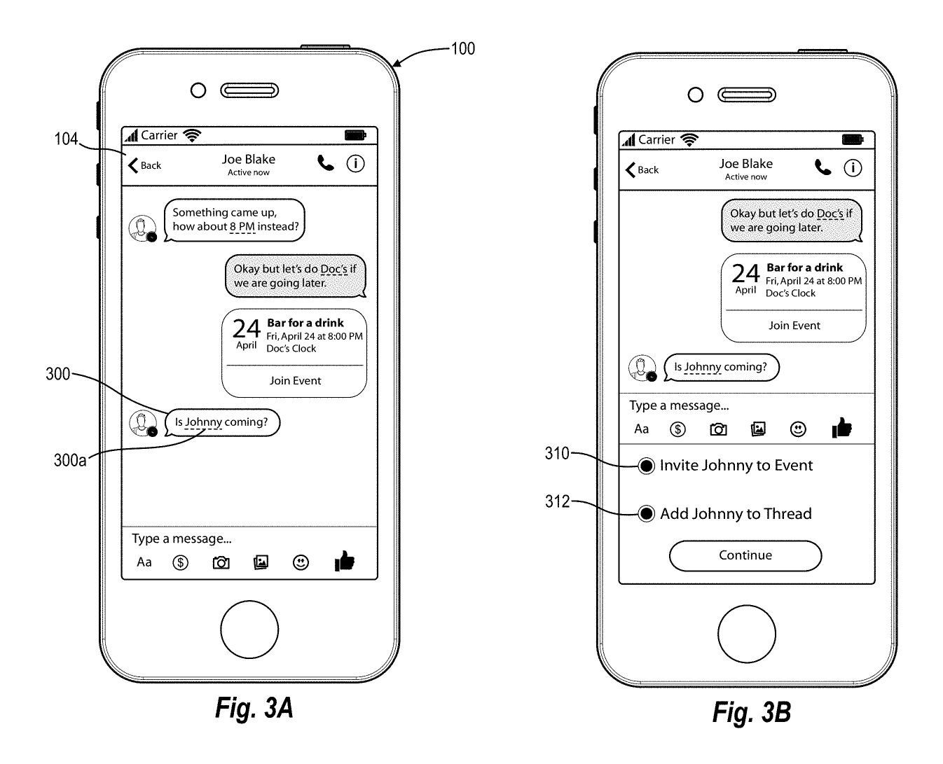

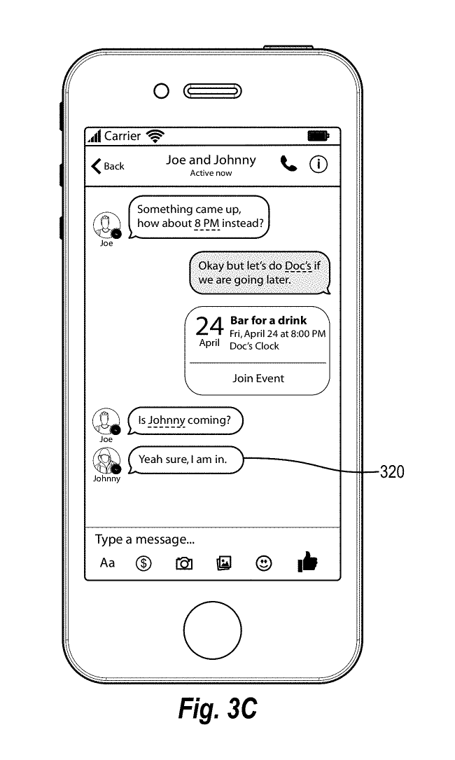

As mentioned previously, in one or more embodiments, the event generation system can also modify electronic communications based on one or more determined event details. In particular, the event generation system can modify participants in a thread of electronic communications based on one or more event details. For example, FIGS. 3A-3C illustrate adding a participant to a thread of electronic communications based on detected event details.

In particular, FIG. 3A illustrates the computing device 100 and the communication user interface 104 with an additional electronic communication 300 (i.e., “Is Johnny coming?”). The event generation system detects an event detail from the electronic communication 300 (i.e., an additional guest, Johnny), and provides an indication 300a signifying availability of an additional event detail.

As illustrated in FIG. 3B, upon user interaction with the indication 300a, the event generation system provides an event invitation element 310 and a thread addition element 312. Upon user interaction with the event invitation element 310, the event generation system sends an invitation to join the digital event to another user (i.e., Johnny). Moreover, upon user interaction with the thread addition element 312, the event generation system adds another user (i.e., Johnny) to the thread of electronic communications.

For example, FIG. 3C illustrates the communication user interface 104 upon adding an additional user to a thread of electronic communications. In particular, based on user interaction with the thread addition element 312, the event generation system adds Johnny to the thread of electronic messages such that messages sent by the user of the computing device are sent to Johnny and Joe (i.e., Joe Blake). Similarly, messages sent by Johnny are received by Joe and the user of the computing device 100. Thus, for example, as shown in FIG. 3C, the event generation system sends the message 320 from user Johnny (i.e. “Yeah sure, I am in”) to Joe Blake and the user of the computing device 100.

In one or more embodiments, the event generation system adds a new participant to a thread of electronic communications and provides the new participant with one or more electronic communications previously included in the thread of electronic communications. For example, with regard to the embodiment of FIG. 3C, the event generation system adds Johnny to the thread of electronic communications and also provides Johnny with a plurality of electronic communications previously sent between the user of the computing device 100 and Joe (i.e., Joe Blake).

In one or more embodiments, the electronic communication system identifies a set of previous electronic communications from a thread to provide to a new participant. For example, in one or more embodiments, the event generation system identifies the earliest communication containing an event detail with regard to the current digital event and provides all subsequent electronic communications to a new participant. Thus, for example, with regard to FIGS. 1A-3C, the event generation system can determine that the electronic communication 108 contains the earliest event detail. Moreover, the event generation system can provide Johnny with the electronic communication 108 and all subsequent electronic communications.

In other embodiments, the electronic communication system identifies a set of previous electronic communications based on a time window (as described above). Indeed, as described previously, the time window can be identified based on a variety of characteristics, including date or time, frequency of communication, clusters of communication, etc.

Moreover, in other embodiments, the electronic communication system provides previous electronic documents from a thread of electronic communications to a new participant by selecting a number of electronic communications. For example, in one or more embodiments, the electronic communication system provides the five most recent electronic communications in a thread to a new participant.

In other embodiments, the event generation system provides all electronic communications in a thread of electronic communications to a new participant. In yet other embodiments, the event generation system does not provide any previous electronic communications, but simply adds the recipient to future electronic communications in the thread.

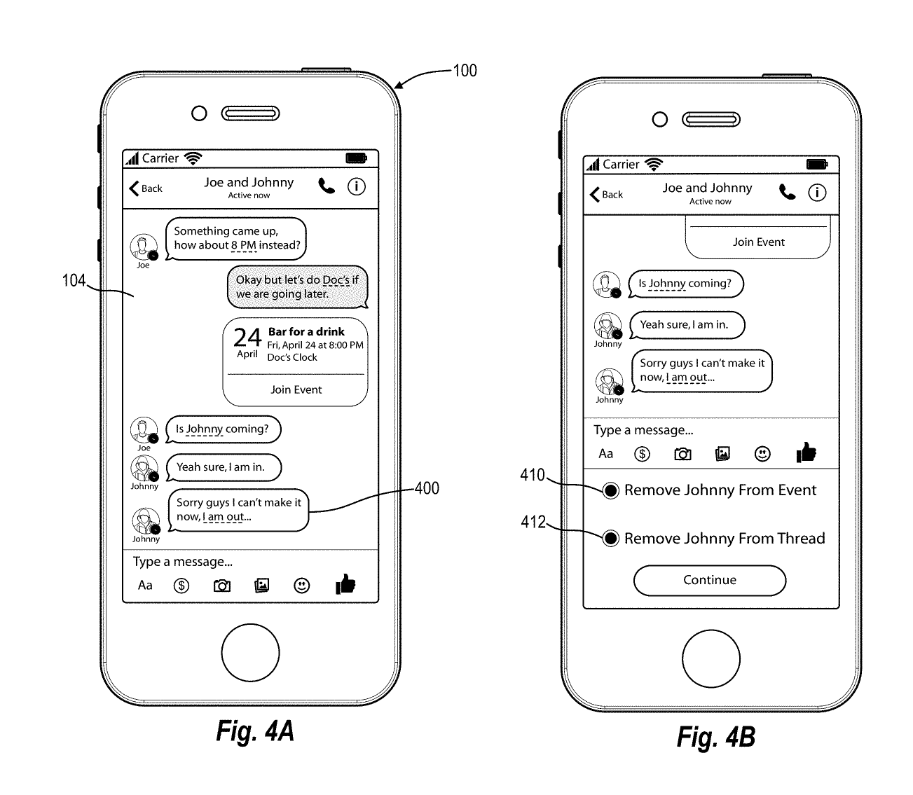

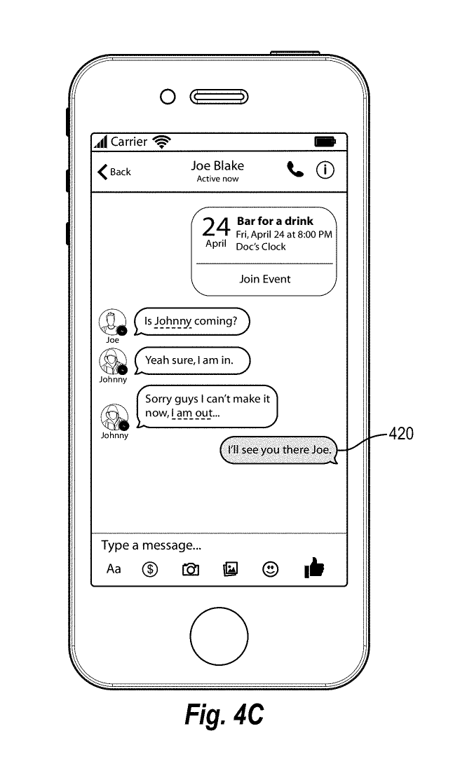

In addition to adding one or more users to a thread of electronic communications, the event generation system can also remove one or more users from a thread of electronic communications. For example, FIG. 4A illustrates the computing device 100 and the communication user interface 104 with an additional electronic communication 400 (i.e., “Sorry guys, I can't make it now, I am out”). As shown, the event generation system detects a modified event detail from the electronic communication 400 (i.e., that Johnny is not able to attend) and provides an indication 400a of an available modified event detail.

As illustrated in FIG. 4B, upon user interaction with the indication 400a, the event generation system provides an event removal element 410 and a thread removal element 412. Based on user interaction with the event removal element 410, the event generation system can remove a participant (i.e., Johnny) from a digital event. Similarly, based on user interaction with the thread removal element 412, the event generation system can remove a participant (i.e., Johnny) from a thread of electronic communications.

Thus, as shown in FIG. 4C, the event generation system removes user Johnny from the thread of electronic communications. In particular, the event generation system removes Johnny such that Johnny will no longer receive additional electronic communications in the thread of electronic communications between the user of the computing device 100 and Joe Blake. Thus, as shown, user Joe Blake receives a new electronic message 420 (i.e., “I'll see you there Joe”), but user Johnny does not receive the new electronic message 420.

Although FIGS. 3A-4C illustrate adding and removing a single participant in a thread of electronic communications, it will be appreciated that the event generation system can add, remove, and organize any number of users with regard to a thread of electronic communications.

For example, in one or more embodiments, the event generation system can create a thread for a sub-group of a plurality of users participating in a thread of electronic communications. In particular, consider a plurality of users participating in a thread of electronic communications. A first user proposes an event with event details. A sub-group of users respond with electronic messages indicating that they wish to attend the event. The event generation system detects the event details, including the sub-group of users that want to attend, and creates a digital event that includes the sub-group of users. The event generation system can also modify the participants of the thread of electronic communications (or create a new thread) so that only the sub-group of users is participating in the thread of electronic communications.

Furthermore, in one or more embodiments, the event generation system can detect a second sub-group of users that respond with electronic messages indicating that they cannot attend. The event generation system can detect those individuals that indicate they cannot attend (i.e., utilizing the natural language processing algorithm) and affirmatively remove the second sub-group of individuals from the thread of electronic communications.

In addition, in one or more embodiments, the event generation system can detect a third sub-group of users that do not respond (i.e., do not indicate whether they are coming to the event or not). In one or more embodiments, the event generation system removes the third sub-group from the thread of electronic communications after a response period has elapsed. For example, the event generation system can determine that a response period has elapsed without any response from the third sub-group of users, and based on the determination, remove the third sub-group of users from the thread of electronic communications.

A response period can comprise a time period or a particular number of electronic messages. For instance, in one or more embodiments the response period comprises a certain number of minutes (e.g., 120 minutes without a response). In other embodiments, the response period can comprise a certain number of electronic messages (e.g., 10 electronic messages sent and/or received without a response from a particular user).

The event generation system can select a response period based on a variety of factors. For example, in one or more embodiments, the event generation system selects a response period based on one or more characteristics of a digital event. For example, the event generation system can select a response period based on the time of the digital event (e.g., if the digital event is in two days, the event generation system can select a response period that is one day). Similarly, the event generation system can select a response period based on the nature of the digital event (e.g., if the event is a formal dinner that requires reservations, the event generation system can select a response period that is shorter than an informal dinner with friends).

In addition, the event generation system can also select a response period based on responses received from one or more other participants. For example, in a thread of electronic communications with five participants, if four participants respond within thirty minutes, the event generation system can select a shorter response period for the fifth participant than if the first four participants responded within two days. Similarly, the event generation system can select a response period based on user history (e.g., the amount of time taken for users to respond to previous events), the number of participants, the time or date, the day of the week, or other factors.

In one or more embodiments, the event generation system modifies the participants in a thread of electronic communications by comparing event details with the participants in a thread of electronic communications. For example, in one or more embodiments, the event generation system detects event details indicating a plurality of individuals attending an event. The event generation system can compare the plurality of individuals to the participants in the thread of communications. Based on the comparison, the event generation system can add participants to the thread of electronic communications (e.g., add individuals included in the event details not included in the thread) or remove participants from the thread of electronic communications (e.g., remove individuals included in the thread that are not included in the event details).

It will be appreciated that although FIGS. 3A-4C illustrate providing elements 312 and 412 for adding or removing users from a thread of electronic communications, in one or more embodiments, the event generation system automatically modifies users in the thread. For example, rather than providing elements 312 and 412, in one or more embodiments, the event generation system adds or removes users in a thread of electronic communications without additional user input. For instance, if the event generation system creates a digital event that includes a user that is not currently included in the thread of electronic communications, in one or more embodiments, the event generation system automatically (without additional user input) adds the user to the thread of electronic communications.

Similarly, in one or more embodiments, the event generation system automatically removes a user from a thread. For example, in one or more embodiments, the event generation system determines that a user participating in a thread is not included in a digital event corresponding to the thread. The event generation system can wait a particular response period (as described above) and then automatically remove the user from the thread.

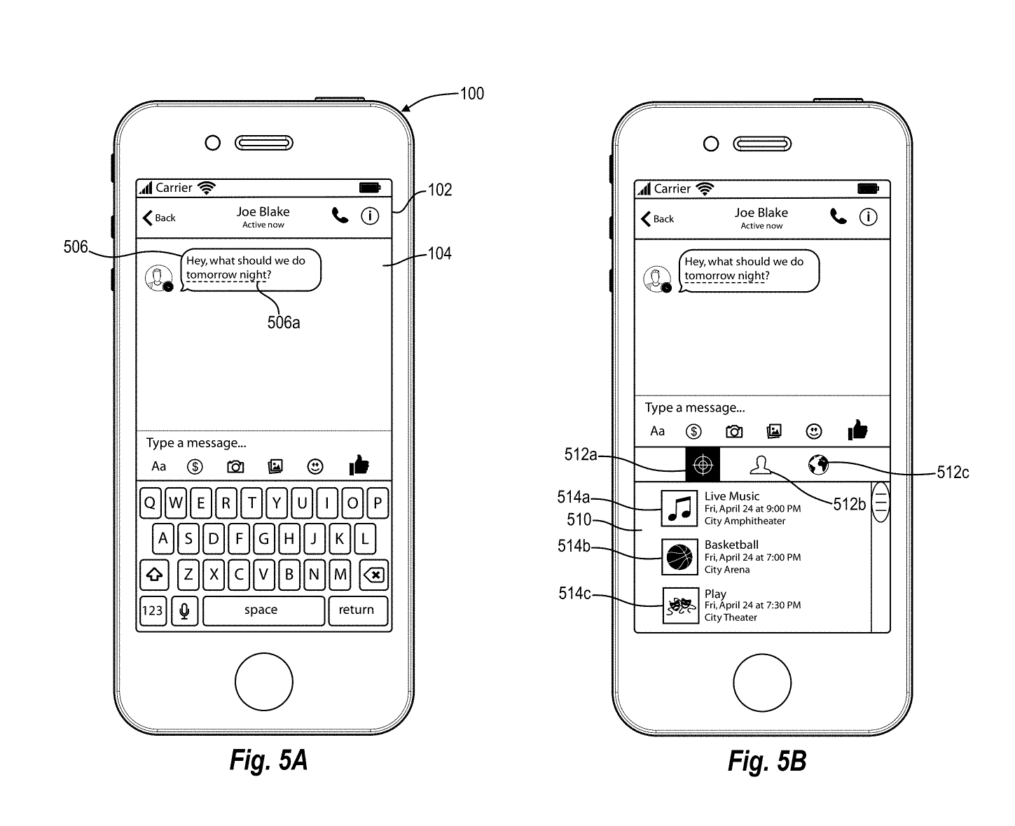

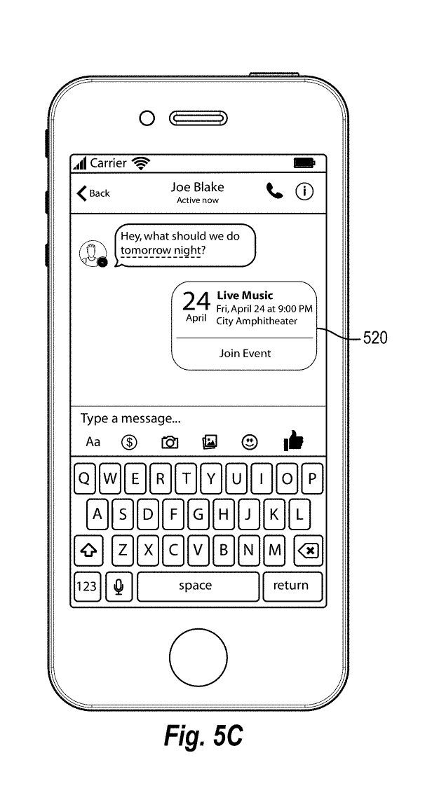

As mentioned previously, in one or more embodiments, the event generation system utilizes existing digital events to detect event details. In addition, in one or more embodiments, the event generation system provides one or more existing digital events for display to a user. For example, the event generation system can provide existing digital events for display to a user to identify event details and/or allow a user to search for events. For example, FIGS. 5A-5C illustrate providing existing digital events for display to a user in accordance with one or more embodiments of the event generation system.

In particular, FIG. 5A illustrates the computing device 100 and the communication user interface 104 displaying an electronic message 506 (i.e., “Hey, what should we do tomorrow night?”). In one or more embodiments, the event generation system detects an event detail (e.g., a time for an event, “tomorrow night”) and provides an indication 506a. The indication 506a signifies that the event generation system can provide assistance in scheduling a digital event.

In particular, as shown in FIG. 5B, upon user interaction with the indication 506a, the event generation system provides an event search area 510. In particular, the event search area 510 includes location search element 512a, user search element 512b, and web search element 512c. Upon user interaction with the location search element 512a, the event generation system provides for display existing digital events based on the current location of the computing device 100 and detected event details (e.g., events in vicinity to the current location and occurring “tomorrow night”).

In addition, upon user interaction with the user search element 512b, the event generation system provides for display existing digital events associated with other users (e.g., digital events that friends of the user of the computing device 100 are attending, following, or interested in). Similarly, upon user interaction with the user web search element 512c, the event generation system provides for display a web search for events corresponding to detected event details (e.g., a web search for events occurring tomorrow night).

Moreover, the event search area 510 also includes event search results 514a-514c. In particular, because the location search element 512a is selected, the event search results 514a-514c reflect existing digital events near the location of the computing device 100 (or some other location, i.e., the location of a user or a user's home).

Upon user interaction with one of the event search results 514a-514c, the event generation system can generate a digital event and/or an event element based on the existing digital event. For example, as illustrated in FIG. 5C, upon user interaction with the event search result 514a, the event generation system creates a digital event corresponding to the event details of the event search result 514a and also sends an event element 520. Thus, as illustrated in FIG. 5C, the event generation system can detect one or more event details, provide existing digital events for display, and generate a new digital event based on the detected one or more event details and existing digital events.

Although not illustrated in FIGS. 5A-5C, in one or more embodiments, upon selection of the event search result 514a, the event generation system provides an event creation user interface (e.g., the event creation user interface 120) that allows a user to review and modify event details prior to sending the event element 520. In other embodiments, as illustrated, the event generation system automatically sends the event element 520 upon user interaction with an existing digital event (e.g., the event search result 514a).

It will be appreciated that although FIGS. 1A-5C illustrate the event generation system operating with regard to a particular thread of electronic communications, in one or more embodiments, the event generation system operates with regard to multiple threads. For example, the event generation system can detect text from electronic communications in multiple threads between different groups of individuals, analyze the text, identify event details, and generate the digital event(s) based on the text from the multiple threads. Furthermore, the event generation system can modify digital events based on text from multiple threads or modify digital threads based on text from multiple threads.

For instance, a first plurality of users (including a particular user) participating in a first thread of electronic communications can begin to plan an event. A second plurality of users (including the particular user) participating in a second thread of electronic communications can send electronic communications indicating that the second plurality of users wishes to join the event. The event generation system can detect event details both from the first thread and the second thread and create a digital event based on the detected event details. Moreover, the event generation system can create a thread of electronic communications that includes both the first and second plurality of users.

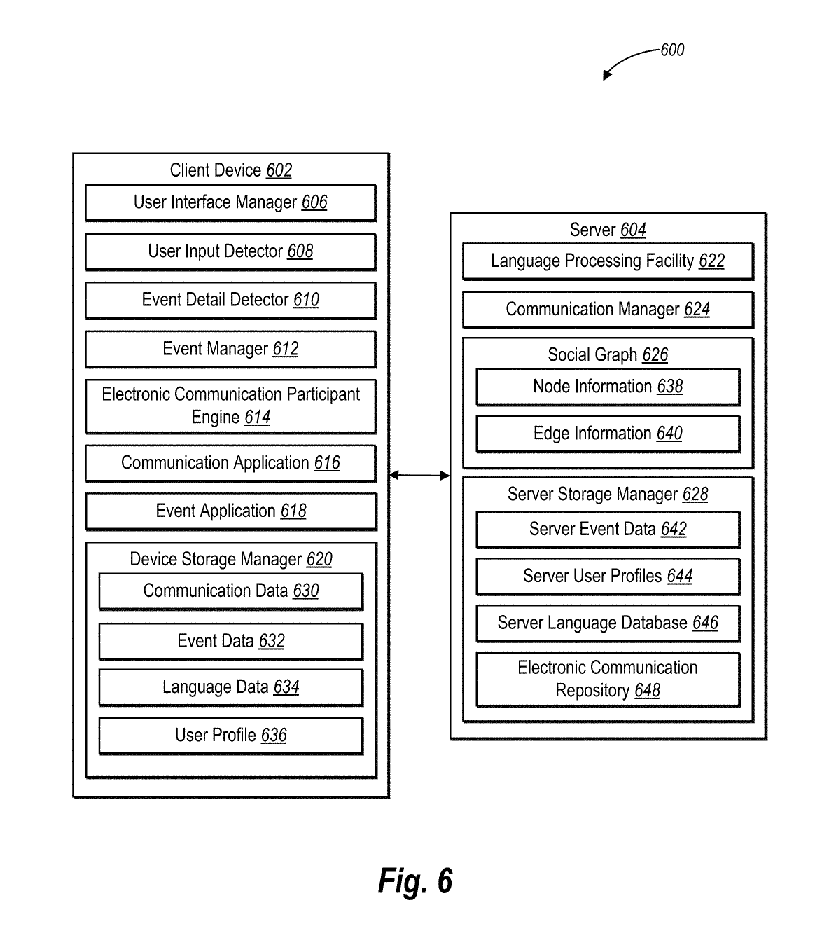

Turning now to FIG. 6, additional detail will be provided regarding various components and capabilities of the event generation system in accordance with one or more embodiments. In particular, FIG. 6 illustrates an example embodiment of an event generation system 600 (i.e., the “event generation system” described above) in accordance with one or more embodiments.

As shown, the event generation system 600 may include, but is not limited to, a client device 602 and a server 604. Moreover, as shown, the client device 602 includes, but is not limited to, a user interface manager 606, a user input detector 608, an event detail detector 610, an event manager 612, an electronic communication participant engine 614, a communication application 616, an event application 618, and a device storage manager 620 (including communication data 630, event data 632, language data 634, and user profile 636).

Furthermore, as shown in FIG. 6, the server 604 includes, but is not limited to, a language processing facility 622, a communication manager 624, a social graph 626 (including node information 638 and edge information 640), and a server storage manager 628 (including server event data 642, server user profiles 644, server language database 646, and electronic communication repository 648).

As just mentioned, and as illustrated in FIG. 6, the client device 602 includes the user interface manager 606. The user interface manager 606 can provide, manage, and/or control a graphical user interface (or simply “user interface”) for use with the event generation system 600. In particular, the user interface manager 606 may facilitate presentation of information by way of an external component of the client device 602. For example, the user interface manager 606 may display a user interface by way of a display screen (e.g., the display screen 102) associated with the client device 602. The user interface may be composed of a plurality of graphical components, objects, and/or elements that allow a user to perform a function. The user interface manager 606 can present, via the client device 602, a variety of types of information, including text, images, video, audio, characters, or other information. Moreover, the user interface manager 606 can provide a variety of user interfaces specific to any variety of functions, programs, applications, plug-ins, devices, operating systems, and/or components of the client device 602 (e.g., the communication user interface 104, the event creation user interface 120, and the event modification user interface 210).

The user interface manager 606 can provide a user interface with regard to a variety of operations or applications (e.g., the communication application 616 and the event application 618). For example, the user interface manager 606 can provide a user interface that facilitates composing, sending, or receiving an electronic communication. Similarly, the user interface manager 606 can generate a user interface that facilitates creating and/or modifying a digital event. In addition, the user interface manager 606 can provide a user interface that facilitates searching or selecting one or more digital events. Additional details with respect to various example user interface elements are described throughout with regard to various embodiments containing user interfaces.

In addition to the user interface manager 606, as shown in FIG. 6, the client device 602 also includes the user input detector 608. The user input detector 608 can detect, identify, monitor, receive, process, capture, and/or record various types of user input. For example, the user input detector 608 may be configured to detect one or more user interactions with respect to a user interface. As referred to herein, a “user interaction” refers to conduct or action performed by a user (or a lack of conduct or action performed by a user) to control the function of a computing device. “User input,” as used herein, refers to input data generated in response to a user interaction.

The user input detector 608 can operate in conjunction with any number of user input devices or computing devices (in isolation or in combination), including personal computers, laptops, smartphones, smart watches, tablets, touchscreen devices, televisions, personal digital assistants, mouse devices, keyboards, track pads, or stylus devices. The user input detector 608 can detect and identify various types of user interactions with user input devices, such as select events, drag events, scroll events, and so forth. For example, in the event the client device 602 includes a touch screen, the user input detector 608 can detect one or more touch gestures (e.g., swipe gestures, tap gestures, pinch gestures, or reverse pinch gestures) from a user that forms a user interaction.

Furthermore, the user input detector 608 can detect or identify user input in any form. For example, the user input detector 608 can detect a user interaction with respect to a variety of user interface elements, such as selection of a graphical button, a drag event within a graphical object, or a particular touch gesture directed to one or more graphical objects or graphical elements of a user interface. Similarly, the user input detector 608 can detect user input directly from one or more user input devices.

The user input detector 608 can communicate with, and thus detect user input with respect to, a variety of programs, applications, plug-ins, operating systems, user interfaces, or other implementations in software or hardware. For example, the user input detector 608 can recognize user input of an electronic communication and/or event details provided in conjunction with the communication application 616.

Moreover, as illustrated in FIG. 6, the client device 602 also includes the event detail detector 610. The event detail detector 610 can identify, determine, detect, calculate, and/or provide one or more event details. In particular, the event detail detector 610 can identify event details from one or more electronic communications.

The event detail detector 610 can detect event details from text in one or more electronic communications utilizing a variety of methods. For example, in one or more embodiments, the event detail detector 610 utilizes natural language processing techniques to detect event details. In particular, as described above, in one or more embodiments, the event detail detector 610 utilizes a trained natural language processing algorithm (e.g., a trained natural language processing algorithm from the language processing facility 622) to identify event details from text in one or more electronic communications.

Moreover, in one or more embodiments, the event detail detector 610 utilizes predetermined character combinations and/or rules (e.g., stored in language data 634) to identify event details. For example, in one or more embodiments, the language processing facility 622 defines predetermined noun/verb combinations and other rules indicative of event details, provides such information to the client device 602 (e.g., to language data 634), and the event detail detector 610 applies the information to determine event details from one or more electronic communications.

As described previously, the event detail detector 610 can also apply one or more time windows. In particular, the event detail detector 610 can apply one or more time windows to limit the text analyzed to determine event details. For example, the event detail detector 610 can select and apply a time window based on a date and/or time, a day of the week, frequency of contact between participants, a cluster of electronic communications, characteristics of an event, characteristics of an electronic communication (e.g., a time of one or more electronic communications), user history, or other factors.

The event detail detector 610 can detect events with regard to any number of electronic communications and/or threads of electronic communications. For example, the event detail detector 610 can detect multiple event details from multiple different threads of electronic communications (e.g., different group instant message threads, different e-mail chains, different text message threads, different social media message threads, or different social media comment threads).

In addition to text from electronic communications, the event detail detector 610 can also identify event details from a variety of other sources. For example, in one or more embodiments the event detail detector 610 determines event details from existing digital events (e.g., event data 632, social graph 626, and/or server event data 642). Similarly, in one or more embodiments the event detail detector 610 determines event details from third-party servers or websites. The event detail detector 610 can also determine event details based on the user profile 636 (e.g., identify location of an event based on the user's location or user history).

For example, with regard to detecting event details from existing digital events, the event detail detector 610 can identify a correspondence between an existing digital event and one or more event details identified from text of one or more electronic communications. Based on the identified correspondence, the event detail detector 610 can supplement the event details detected from the text of the one or more electronic communications with one or more event details from the existing digital event.

In addition, as shown in FIG. 6, the client device 602 also includes the event manager 612. The event manager 612 can create, generate, modify, analyze, produce, and/or receive one or more digital events. In particular, the event manager 612 can generate digital events based on one or more event details (e.g., event details from the event detail detector 610).

The event manager 612 can also provide one or more indications with regard to the features or capabilities of the event generation system 600. For example, the event manager 612 can provide an indication (or suggestion) that the event generation system 600 has detected one or more event details and can create a digital event. Similarly, the event manager 612 can provide an indication (or suggestion) regarding modified event details or existing digital events.

In one or more embodiments, the event manager 612 compares event details to one or more thresholds prior to surfacing an indication. For example, in one or more embodiments, the event manager 612 applies a minimum event detail threshold before providing an indication that the event generation system can create a digital event. As described above, the minimum event detail threshold can comprise a number of event details, a certainty of event details (e.g., a likelihood that detected event details accurately reflect actual event details of a particular event), or some other factor.

In addition, the event manager 612 can also apply other thresholds. For example, in one or more embodiments, the event manger 612 also applies a supplemental event detail threshold. In particular, in one or more embodiments, the event manager 612 applies a supplemental event detail threshold with regard to automatically generating a digital event (or automatically presenting an event creation user interface). Specifically, in one or more embodiments the event manager 612 applies a supplemental event detail threshold that is more stringent than a minimum event detail threshold, and automatically (i.e., without additional user interaction with an indication that event details are available) generates a digital event (or presenting an event creation user interface) upon satisfaction of the supplemental event detail threshold.

As mentioned, the event manager 612 can create one or more digital events. In particular, the event manager 612 can create a digital event and store the digital event on the client device 602 (e.g., via event data 632) or on the server 604 (e.g., via server event data 642 and/or social graph 626).

The event manager 612 can also modify one or more digital events. For instance, the event manager 612 can modify one or more digital events based on additional or modified event details. For example, the event manager 612 can receive one or more additional or modified event details (e.g., from event detail detector 610) and modify a digital event based on the one or more additional or modified event details. Specifically, after creation of a digital event, the event detail detector 610 can detect modified event details (e.g., from text of one or more electronic communications) and the event manager 612 can utilize the modified event details to modify the digital event.

The event manager 612 can also modify a digital event based on changes to another digital event. For example, as mentioned above, the event generation system 600 (e.g., via the event detail detector 610) can determine a correspondence between a new digital event and an existing digital event. The event generation system 600 can detect modifications to event details in the existing digital event and modify event details in the new digital event. Similarly, in one or more embodiments, the event generation system 600 can detect modifications to event details in the new digital event and modify event details in the existing digital event based on the detected modifications to the new digital event.

As shown in FIG. 6, the client device 602 also includes the electronic communication participant engine 614. The electronic communication participant engine 614 can add, remove, organize, and/or modify one or more participants in an electronic communication or thread of electronic communications. For example, the electronic communication participant engine 614 can modify a number of users participating in a messaging group.

As described above, the electronic communication participant engine 614 can modify participants in thread of electronic communications based on one or more event details. In particular, the electronic communication participant engine 614 can compare one or more event details (e.g., event attendees) with the users participating in a thread of electronic communications and modify the users participating in the thread of electronic communications based on the comparison.

For example, the electronic communication participant engine 614 can receive an event detail (e.g., based on text from one or more electronic communications identified by the event detail detector 610) indicating that a user that is not included in a thread of electronic communications is included in a particular event. Based on the received event detail, the electronic communication participant engine 614 can add the user to the thread of electronic communications.

Aside from adding users, the electronic communication participant engine 614 can remove users from a thread of electronic communications. For example, the electronic communication participant engine 614 can remove users based on text indicating that a user cannot attend an event, based on a lack of response from a user for a particular response period (e.g., a user fails to respond to an invitation within a response period), or some other factor.

The electronic communication participant engine 614 can also create a new thread of electronic communications (e.g., based on a new digital event with a plurality of new attendees, the electronic communication participant engine 614 can create a new thread of electronic communications that includes all attendees). As described above, the electronic communication participant engine 614 can add a user to a thread of electronic communications (e.g., provide the user with a certain number of previous electronic communications from the thread of electronic communications). Moreover, the electronic communication participant engine 614 can combine multiple threads of electronic communications (e.g., combine two lists of participants from two threads into a single thread).

In addition, the electronic communication participant engine 614 can also automatically name a messaging group. For instance, in one or more embodiments, the electronic communication participant engine 614 names a messaging group based on one or more event details. For example, for a messaging group planning a trip to New York the electronic communication participant engine 614 can apply a name to the messaging group based on detected event details, such as “New York Trip.” The electronic communication participant engine 614 can generate a name based on location, date or time, attendees, or any other event detail.

The electronic communication participant engine 614 can modify any type or form of electronic communication. Thus, the electronic communication participant engine 614 can modify participants with regard to instant messages, e-mail messages, text messages, SMS messages, social media messages, or any other digital group messages.

As mentioned previously, in one or more embodiments, the event generation system 600 seamlessly transitions between multiple applications in performing its functions, such as a communication application and a social media application. Accordingly, as illustrated in FIG. 6, the client device 602 also includes the communication application 616. The communication application 616 can send, receive, create, generate, transmit, and/or provide one or more electronic communications. Moreover, the communication application 616 can also send, receive, create, generate, transmit and/or provide one or more event elements within an electronic communication (as described above).

In one or more embodiments, the communication application 616 implements all or part of one or more components of the event generation system 600. For example, in one or more embodiments, the communication application 616 implements portions of the event manager 612, by providing indications of one or more available events or event details to a user. Similarly, in one or more embodiments, the communication application 616 implements the electronic communication participant engine 614 by generating threads of electronic communications that include various users.

In addition to the communication application 616, as shown in FIG. 6, the client device 602 also includes the event application 618. The event application 618 comprises any application that generates or utilizes digital events. For example, the event application 618 can comprise a calendaring application, a scheduling application, a web browser, or a social media application. Thus, in one or more embodiments, the event application 618 comprises a social media application operable to interact with the social graph 626, and the server 604 provides a social networking system.

Like the communication application 616, the event application 618 can also implement all or a portion of one or more components of the event generation system 600. For example, the event generation system 600 can implement the event manager 612 in creating one or more digital events and storing the one or more digital events on the client device 602 and/or the server 604.

Accordingly, as mentioned above, the event generation system 600 can seamlessly and/or implicitly (i.e., without user input opening and closing separate applications and/or without users being aware that they are opening and closing separate applications) transition between applications performing functions of the event generation system 600. For example, the communication application 616 can present an indication of available event details, the event application 618 can present a user interface for creation of a digital event, the event application 618 can create and store the digital event, and the communication application 616 can send an event element with event details from the created digital event.

As illustrated in FIG. 6, the client device 602 also includes the device storage manager 620. The device storage manager 620 maintains data on the client device 602 for the event generation system 600. The device storage manager 620 can maintain data of any type, size, or kind, as necessary to perform the functions of the event generation system 600.

As shown in FIG. 6, the device storage manager 620 includes communication data 630. Communication data 630 includes any data related to electronic communications sent, received, created, and/or generated by the event generation system 600. For example, communication data 630 includes text of one or more electronic communications; data indicating the sender and/or recipient of the electronic communications; data indicating the time that electronic communications were sent, received, viewed, or accessed; and other data related to electronic communications.

In addition, as illustrated in FIG. 6, the device storage manager 620 also includes event data 632. Event data 632 includes any data related to events stored by the client device 602. For example, event data 632 includes any event details detected by the event detail detector 610, any digital events created by the event manager 612, data indicating the organizer of digital events, and any other data related to digital events.

Moreover, as shown in FIG. 6, the device storage manager 620 also includes language data 634. Language data 634 includes any information utilized by the client device 602 to analyze text of one or more electronic communications. For example, language data 634 can include a trained natural language processing algorithm. Similarly, language data 634 can include a database of predetermined characters (nouns, verbs, etc.) and/or rules utilized to identify event details from text of one or more electronic communications.

In one or more embodiments, the client device 602 receives language data 634 from the server 604. For example, in one or more embodiments, the server 604 generates a trained natural language processing algorithm (e.g., via the language processing facility 622) and provides the natural language processing algorithm to the client device 602 as language data 634. Similarly, the server 604 can provide a database of characters or rules indicative of event details (e.g., from server language database 646) to the client device 602 (e.g., to language data 634).

In addition, as shown in FIG. 6, the device storage manager 620 also includes the user profile 636. The user profile 636 includes information regarding the client device 602 and any users of the client device 602. The user profile 636 includes user history (e.g., history of actions performed by the users of the client device), location information, contact information, demographic information, and any other information available regarding the user or the client device (subject to privacy and data settings or preferences of the user and/or the client device 602).

Furthermore, as shown in FIG. 6, the server 604 includes the language processing facility 622. The language processing facility 622 can generate, create, train, utilize, employ, produce, and/or provide one or more natural language processing algorithms. Similarly, the language processing facility 622 can identify, generate, create, produce, and/or provide characters and/or rules for identifying event details from text of one or more electronic communications.

The language processing facility 622 can train a natural language processing algorithm utilizing a corpus of electronic communications (e.g., the electronic communication repository 648). In particular, as described above, the language processing facility 622 can provide a natural language processing algorithm with electronic communications and known event details corresponding to the electronic communications and train the natural language processing algorithm to predict event details from one or more electronic communications.

The language processing facility 622 can also generate a determined set of characters and/or rules for identifying event details. For example, the language processing facility 622 can determine that the words “I'll be there” indicate an assent by an individual to participate in an event. Similarly, the language processing facility 622 can determine that “See you at 8” indicates an intent by an individual to meet at a particular time. The language processing facility 622 can produce a database of characters and rules that reflect these determinations.

The language processing facility 622 can also apply a trained natural language processing algorithm (or a database of characters and rules) to identify one or more event details. Indeed, in one or more embodiments, the language processing facility 622 identifies text from electronic communications (e.g., from the communication manager 624) and identifies event details. The language processing facility 622 can provide detected event details with the client device 602 (e.g., to the event detail detector 610).

As shown in FIG. 6, the server 604 also includes the communication manager 624. The communication manager 624 can facilitate receiving and sending data. In particular, the communication manager 624 can facilitate sending and receiving electronic communications. Specifically, the communication manager 624 can receive and send electronic communications between the client device 602 and another client device. For example, the communication manager 624 can package content to be included in an electronic communication and format the electronic communication in any necessary form that is able to be sent through one or more communication channels and using an appropriate communication protocol. Furthermore, the communication manager 624 can facilitate communication between the server 604 and the client device 602.

As further illustrated in FIG. 6, in the case of the event generation system 600 comprising a social networking system, the event generation system 600 may include a social graph 626 for representing and analyzing a plurality of users and concepts. As shown in FIG. 6, the social graph 626 can include node information 638 that stores information comprising nodes for users, nodes for concepts, and/or nodes for items. In addition, the social graph 626 can include edge information 640 comprising relationships between nodes and/or actions occurring within the social networking system. Further detail regarding social networking systems, social graphs, edges, and nodes is presented below.

As shown in FIG. 6, the server 604 may also contain the server storage manager 628. The server storage manager 628 maintains data for the event generation system 600 on the server 604. The server storage manager 628 can maintain data of any type, size, or kind, as necessary to perform the functions of the event generation system 600.

As illustrated in FIG. 6, the server storage manager 628 includes server event data 642. Server event data 642 includes any data related to digital events stored on the server 604. For example, server event data 642 includes event details of digital events, information regarding the creator of the digital events, and any other data related to digital events. In one or more embodiments, the server 604 receives information regarding digital events (e.g. event details) from the client device 602 and other client devices. The server 604 can combine the received event details and store them as server event data 642.

Moreover, as shown in FIG. 6, the server storage manager 628 also includes server user profiles 644. The server user profiles 644 include information regarding users of the event generation system 600 and/or client devices utilized by users of the event generation system 600. The server user profiles 644 include user history, location information, contact information, demographic information, and any other information available regarding users of the event generation system (subject to privacy and data settings or preferences).

In addition, as illustrated in FIG. 6, the server storage manager 628 also includes the server language database 646. The server language database 646 includes information utilized by the server 604 to analyze text of one or more electronic communications for event details. For example, the server language database 646 includes one or more trained natural language processing algorithms. Similarly, the server language database 646 includes one or more databases containing predetermined characters and/or rules for identifying event details from text of one or more electronic documents.

As shown in FIG. 6, the server storage manager 628 also includes electronic communication repository 648. The electronic communication repository 648 includes any collection of electronic communications. For instance, the electronic communication repository 648 can comprise a collection of e-mail messages, text messages, instant messages, social media messages, or a collection of any other type of electronic communications.

In addition, the electronic communication repository 648 contains information indicating known event details corresponding to text of electronic communications contained in the electronic communication repository 648. Thus, for example, where the electronic communication repository 648 contains an electronic communication with text stating, “let's meet at 6,” the electronic communication repository 648 may also contain information indicating that the electronic communication corresponds to an event scheduled for 6:00.

In one or more embodiments, the server 604 builds the electronic communication repository 648 utilizing electronic communications and event data from a plurality of client devices (e.g., the client device 602). For example, the server 604 can receive communication data 630 from the client device 602 together with corresponding event data 632 from the client device 602 and build the electronic communication repository 648 based on the communication data 630 and the event data 632.

In this manner, the event generation system 600 can maintain an updated repository of electronic communications that can train a natural language processing algorithm (e.g., via the language processing facility 622) over time. Thus, the event generation system 600 can accurately identify new language usage patterns in identifying event details from text of one or more electronic documents.

Each of the components 606-628 of the event generation system 600 and their corresponding elements may be in communication with one another using any suitable communication technologies. It will be recognized that although components 606-628 and their corresponding elements are shown to be separate in FIG. 6, any of components 606-628 and their corresponding elements may be combined into fewer components, such as into a single facility or module, divided into more components, or configured into different components as may serve a particular embodiment.

The components 606-628 and their corresponding elements can comprise software, hardware, or both. For example, the components 606-628 and their corresponding elements can comprise one or more instructions stored on a computer-readable storage medium and executable by processors of one or more computing devices. When executed by the one or more processors, the computer-executable instructions of the event generation system 600 can cause the client device 602 and/or the server 604 to perform the methods described herein. Alternatively, the components 606-628 and their corresponding elements can comprise hardware, such as a special purpose processing device to perform a certain function or group of functions. Additionally or alternatively, the components 606-628 and their corresponding elements can comprise a combination of computer-executable instructions and hardware.

Furthermore, the components 606-628 of the event generation system 600 may, for example, be implemented as one or more stand-alone applications, as one or more modules of an application, as one or more plug-ins, as one or more library functions or functions that may be called by other applications, and/or as a cloud-computing model. Thus, the components 606-628 of the event generation system 600 may be implemented as a stand-alone application, such as a desktop or mobile application. Furthermore, the components 606-628 of the event generation system 600 may be implemented as one or more web-based applications hosted on a remote server. Alternatively or additionally, the components of the event generation system 600 may be implemented in a suit of mobile device applications or “apps.”

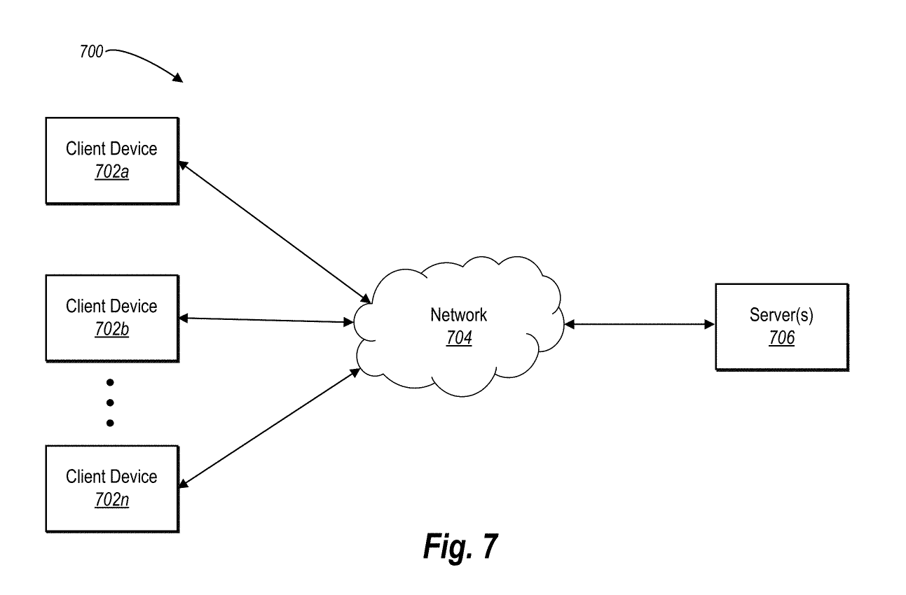

Turning now to FIG. 7, further information will be provided regarding implementation of the event generation system 600. Specifically, FIG. 7 illustrates a schematic diagram of one embodiment of an exemplary system environment (“environment”) 700 in which the event generation system 600 can operate. As illustrated in FIG. 7, the environment 700 can include client devices 702a-702n, a network 704, and server(s) 706. The client devices 702a-702n, the network 704, and the server(s) 706 may be communicatively coupled with each other either directly or indirectly (e.g., through the network 704). The client devices 702a-702n, the network 704, and the server(s) 706 may communicate using any communication platforms and technologies suitable for transporting data and/or communication signals, including any known communication technologies, devices, media, and protocols supportive of remote data communications, examples of which will be described in more detail below.

As just mentioned, and as illustrated in FIG. 7, the environment 700 can include the client devices 702a-702n. The client devices 702a-702n (e.g., the client device 602 or the computing device 100) may comprise any type of computing device. For example, the client devices 702a-702n may comprise one or more personal computers, laptop computers, mobile devices, mobile phones, tablets, special purpose computers, TVs, or other computing devices. In one or more embodiments, the client devices 702a-702n may comprise computing devices capable of communicating with each other or the server(s) 706. The client devices 702a-702n may comprise one or more computing devices as discussed in greater detail below.

As illustrated in FIG. 7, the client devices 702a-702n and/or the server(s) 706 may communicate via the network 704. The network 704 may represent a network or collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the network 704 may be any suitable network over which the client devices 702a-702n (or other components) may access the server(s) 706 or vice versa. The network 704 will be discussed in more detail below.

Moreover, as illustrated in FIG. 7, the environment 700 also includes the server(s) 706. The server(s) 706 (e.g., the server 604) may generate, store, receive, and/or transmit any type of data, including sever event data 642, server user profiles 644, server language database 646, electronic communications or any other data (e.g., data stored by the device storage manager 620). For example, the server(s) 706 may receive data from the client device 702a and send the data to the client device 702b. In one example, server(s) 706 comprise a social networking server that can host a social network. In one or more embodiments, the server(s) 706 may comprise a data server. The server(s) 706 can also comprise a communication server or a web-hosting server. Regardless, the server(s) 706 can be configured to receive a wide range of electronic documents or communications, including but not limited to, text messages, instant messages, social networking messages, social networking posts, emails, tags, comments, and any other form of electronic communications or electronic documents. Additional details regarding the server(s) 706 will be discussed below.

Although FIG. 7 illustrates three client devices 702a-702n, it will be appreciated that the client devices 702a-702n can represent any number of computing devices (fewer or greater than shown). Similarly, although FIG. 7 illustrates a particular arrangement of the client devices 702a-702n, the network 704, and the server(s) 706, various additional arrangements are possible.

In addition to the elements of the environment 700, one or more users can be associated with each of the client devices 702a-702n. For example, users may be individuals (i.e., human users). The environment 700 can include a single user or a large number of users, with each of the users interacting with the event generation system 600 through a corresponding number of computing devices. For example, a user can interact with the client device 702a for the purpose of composing and sending an electronic communication (e.g., instant message). The user may interact with the client device 702a by way of a user interface on the client device 702a. For example, the user can utilize the user interface to cause the client device 702a to create and send an electronic communication to one or more of the plurality of users of the event generation system 600.

By way of an additional example, in one or more embodiments the client device 702a receives user input of a first electronic communication (e.g., via the communication application 616) and transmits the electronic communication to the server(s) 706 via the network 704. The server(s) 706 transmits the first electronic communication to the client device 702b via the network 704, the client device 702b receives a second electronic communication and transmits the second electronic communication to the client device 702a via the network 704 and the server(s) 706. The client device 702a and/or the server(s) 706 detect a plurality of event details (e.g., utilizing the event detail detector 610 and/or the language processing facility 622) from the first and second electronic communications utilizing a trained natural language processing algorithm. Moreover, the client device 702a utilizes the detected event details to generate a digital event (e.g., utilizing the event manager 612 and/or the event application 618) and transmit the digital event to the client device 702b via the network 704 and the server(s) 706. Moreover, based on the digital event and text from the electronic communications, the client device 702a can add a participant (e.g., utilizing the electronic communication participant engine 614) to receive the digital event and further electronic communications. Specifically, the client device 702a can add the user associated with client device 702n. Furthermore, the client device 702a can send the digital event and/or a third electronic communication to the client device 702n via the network 704 and the server(s) 706.

As illustrated by the previous example embodiment, the event generation system 600 may be implemented in whole, or in part, by the individual elements 702a-706 of the environment 700. Although the previous example, described certain components of the event generation system 600 implemented with regard to certain components of the environment 700, it will be appreciated that components of the event generation system 600 can be implemented in any of the components of the environment 700. For example, in one or more embodiments, the event detail detector 610 and/or the event manager 612 can be implemented on the server(s) 706. Similarly, in one or more embodiments, the language processing facility 622 may be implemented (in whole or in part) on the client device 702a.

Moreover, the event generation system 600 and/or the server(s) 706 can actively collect information independently of a particular client device and independent of other components of the environment 700. For example, the event generation system 600 and/or server(s) 706 can actively collect information from interaction between users and the server(s) 706 (or other servers). Specifically, in one or more embodiments, the event generation system 600 actively collects event data, event details, and electronic communications (e.g., the event data 632 and communication data 630). For example, the event generation system can actively collect electronic communications and corresponding digital events based on user interaction with one or more client devices. Moreover, the event generation system 600 can utilize collected information (e.g., event data or electronic communications) to train a natural language processing algorithm (e.g., as part of the electronic communications repository 648).

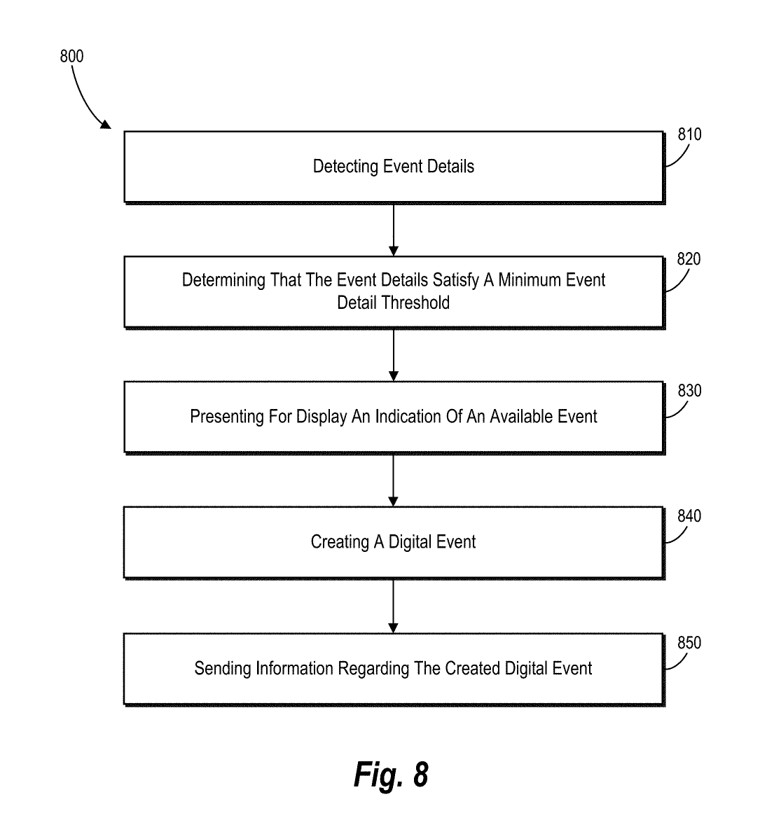

FIGS. 1-7, the corresponding text, and the examples, provide a number of different systems and devices for generating digital events. In addition to the foregoing, embodiments can also be described in terms of flowcharts comprising acts and steps in a method for accomplishing a particular result. For example, FIG. 8 illustrates a flowchart of an exemplary method in accordance with one or more embodiments of the present invention. The method described in relation to FIG. 8 may be performed with less or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart of a series of acts in a method 800 of generating digital events in accordance with one or more embodiments of the present invention. In one or more embodiments, the method 800 is performed in a digital medium environment that includes the event generation system 600. The event generation system 600 may provide a system that allows a user to create one or more digital events based on text of one or more electronic communications. The method 800 is intended to be illustrative of one or more methods in accordance with the present disclosure, and is not intended to limit potential embodiments. Alternative embodiments can include additional, fewer, or different steps than those articulated in FIG. 8.

As shown in FIG. 8, the method 800 includes an act 810 of detecting event details. In particular, the act 810 can include detecting, by at least one processor, event details from text in at least one electronic communication shared between a plurality of users of a communication application. Moreover, in one or more embodiments, the act 810 includes detecting a first event detail from first text in a first electronic communication between the plurality of users; and detecting a second event detail from second text in a second electronic communication between the plurality of users.

Furthermore, the act 810 can also include identifying a time window based on one or more characteristics of the at least one electronic communication; limiting the at least one electronic communication to a set of one or more electronic communications that fall within the time window; and detecting event details by analyzing the set of one or more electronic communications that fall within the time window. In addition, in one or more embodiments, the one or more characteristics of the at least one electronic communication comprise at least one of the following: an amount of time between electronic communications, a date of the at least one electronic communication, or a time of the at least one communication.

As illustrated in FIG. 8, the method 800 also includes an act 820 of determining that the event details satisfy a minimum event detail threshold. In particular, the act 820 can include determining, by the at least one processor, that the event details from the text in the at least one electronic communication satisfy a minimum event detail threshold. For example, in one or more embodiments, the minimum event detail threshold comprises a number of detected event details corresponding to a created digital event, the number of detected event details being greater than one.

In addition, as shown in FIG. 8, the method 800 also includes an act 830 presenting for display an indication of an event. In particular, the act 830 can include based on the determination that the event details satisfy the minimum event detail threshold, presenting for display an indication of an event to the plurality of users. For example, in one or more embodiments, the act 830 includes presenting an indication of the event with regard to the first text and/or the second text.

As illustrated in FIG. 8, the method 800 also includes an act 840 of creating a digital event. In particular, the act 840 can include based on user interaction with the presented indication, creating a digital event. For example, in one or more embodiments, the act 840 includes creating a digital event utilizing the first event detail and the second event detail. In addition, in one or more embodiments, the act 840 includes accessing a plurality of existing digital events created by users of an online social network; comparing the detected event details to the plurality of existing digital events; based on the comparison, identifying at least one existing digital event from the plurality of existing digital events created by users of the online social network that correspond to the detected event details; and creating the digital event based, at least in part, on the identified at least one existing digital event from the plurality of existing digital events created by users of the online social network.

Furthermore, as shown in FIG. 8, the method 800 also includes an act 850 of sending information regarding the created digital event. In particular, the act 850 can include sending information regarding the created digital event to at least one of the plurality of users via the communication application.

In one or more embodiments, the method 800 also includes, after creating the digital event, identifying one or more additional event details from one or more additional electronic communications between the plurality of users; and modifying the digital event based on the one or more additional event details.

Similarly, in one or more embodiments, the plurality of users are participating in a thread of electronic messages. Moreover, the method 800 further comprises: modifying the number of users participating in the thread of electronic messages based on the digital event. For instance, in one or more embodiments, the method 800 includes determining that at least one user of the plurality of users participating in the thread of electronic messages is not part of the digital event; and removing the at least one user that is not part of the digital event from participating in the thread of electronic messages.

Furthermore, in one or more embodiments, the method 800 includes detecting a modification to the at least one existing digital event from the plurality of existing digital events created by users of the online social network; and modifying the created digital event based on the modification to the at least one existing digital event from the plurality of events created by the users of the online social network.

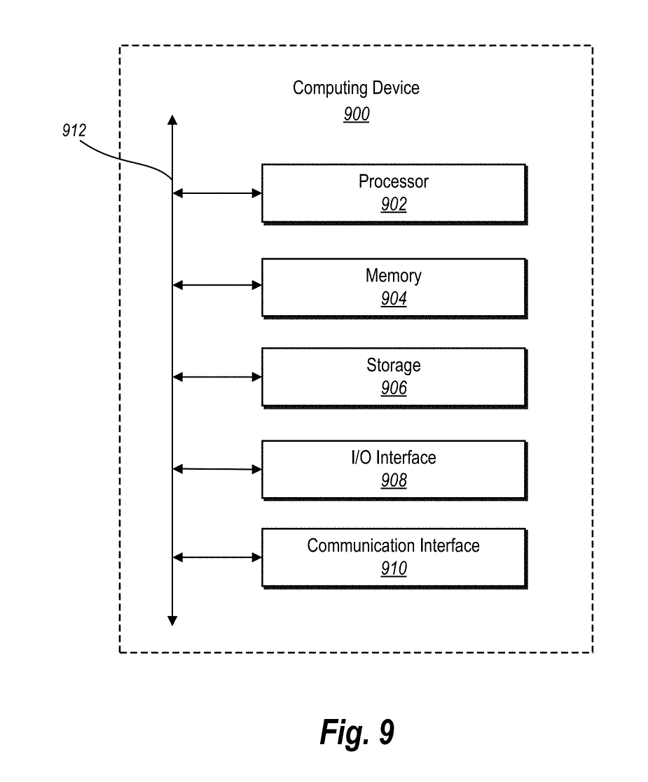

FIG. 9 illustrates, in block diagram form, an exemplary computing device 900 that may be configured to perform one or more of the processes described above. One will appreciate that the computing device 100, the event generation system 600, the client device 602, the server 604, the environment 700, the client devices 702a-702n, and the server(s) 706 each comprise one or more computing devices in accordance with implementations of computing device 900. As shown by FIG. 9, the computing device can comprise a processor 902, a memory 904, a storage device 906, an I/O interface 908, and a communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other embodiments. Furthermore, in certain embodiments, a computing device 900 can include fewer components than those shown in FIG. 9. Components of computing device 900 shown in FIG. 9 will now be described in additional detail.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage device 906 and decode and execute them. In particular embodiments, processor 902 may include one or more internal caches for data, instructions, or addresses. As an example and not by way of limitation, processor 902 may include one or more instruction caches, one or more data caches, and one or more translation lookaside buffers (TLBs). Instructions in the instruction caches may be copies of instructions in memory 904 or storage 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 904 may be internal or distributed memory.

Storage device 906 includes storage for storing data or instructions. As an example and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to the computing device 900. In particular embodiments, storage device 906 is non-volatile, solid-state memory. In other embodiments, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, event generation system 600 may be linked to and/or implemented within a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g. wall posts, photo-sharing, event organization, messaging, games, or advertisements) to facilitate social interaction between or among users.

The social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social networking system a request to create an edge between a user node of the user and a concept node of the concept, indicating a relationship between the user and the concept (e.g., the user checks in to a restaurant, or the user “likes” a celebrity).

As an example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia files to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

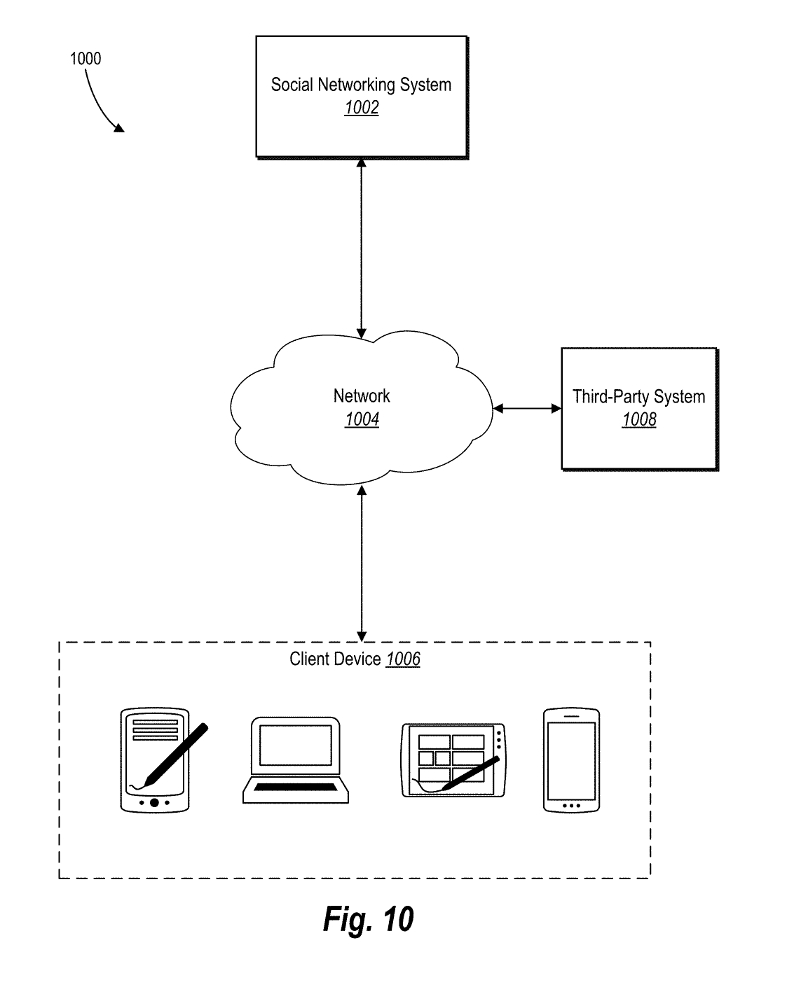

FIG. 10 illustrates an example network environment of a social networking system. In particular embodiments, a social networking system 1002 may comprise one or more data stores. In particular embodiments, the social networking system 1002 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social networking system 1002 may comprise one or more computing devices (e.g., servers) hosting functionality directed to operation of the social networking system 1002. A user of the social networking system 1002 may access the social networking system 1002 using a client device such as client device 1006. In particular embodiments, the client device 1006 can interact with the social networking system 1002 through a network 1004.

The client device 1006 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1006 may access the social networking system 1002.

While these methods, systems, and user interfaces utilize both publicly available information as well as information provided by users of the social networking system, all use of such information is to be explicitly subject to all privacy settings of the involved users and the privacy policy of the social networking system as a whole.

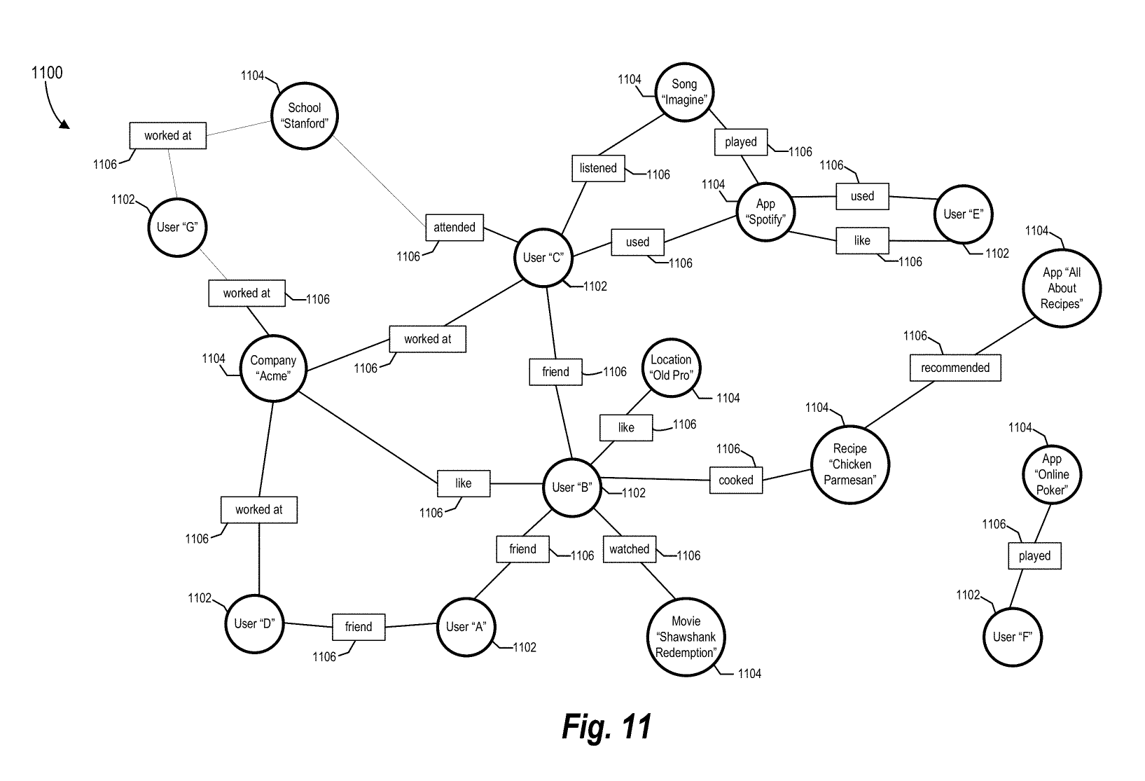

FIG. 11 illustrates example social graph 1100. In particular embodiments, social networking system 1002 may store one or more social graphs 1100 in one or more data stores. In particular embodiments, social graph 1100 may include multiple nodes—which may include multiple user nodes 1102 or multiple concept nodes 1104—and multiple edges 1106 connecting the nodes. Example social graph 1100 illustrated in FIG. 11 is shown, for didactic purposes, in a two-dimensional visual map representation. In particular embodiments, a social networking system 1002, client device 1006, or third-party system 1008 may access social graph 1100 and related social-graph information for suitable applications. The nodes and edges of social graph 1100 may be stored as data objects, for example, in a data store (such as a social-graph database). Such a data store may include one or more searchable or query able indexes of nodes or edges of social graph 1100.

In particular embodiments, a user node 1102 may correspond to a user of social networking system 1002. As an example and not by way of limitation, a user may be an individual (human user), an entity (e.g., an enterprise, business, or third-party application), or a group (e.g., of individuals or entities) that interacts or communicates with or over social networking system 1002. In particular embodiments, when a user registers for an account with social networking system 1002, social networking system 1002 may create a user node 1102 corresponding to the user, and store the user node 1102 in one or more data stores. Users and user nodes 1102 described herein may, where appropriate, refer to registered users and user nodes 1102 associated with registered users. In addition or as an alternative, users and user nodes 1102 described herein may, where appropriate, refer to users that have not registered with social networking system 1002. In particular embodiments, a user node 1102 may be associated with information provided by a user or information gathered by various systems, including social networking system 1002. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 1104 may correspond to a concept. As an example and not by way of limitation, a concept may correspond to a place (such as, for example, a movie theater, restaurant, landmark, or city); a website (such as, for example, a website associated with social network system 1002 or a third-party website associated with a web-application server); an entity (such as, for example, a person, business, group, sports team, or celebrity); a resource (such as, for example, an audio file, video file, digital photo, text file, structured document, or application) which may be located within social networking system 1002 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1104 may be associated with information of a concept provided by a user or information gathered by various systems, including social networking system 1002. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1104 may be associated with one or more data objects corresponding to information associated with concept node 1104. In particular embodiments, a concept node 1104 may correspond to one or more webpages.

In particular embodiments, a node in social graph 1100 may represent or be represented by a webpage (which may be referred to as a “profile page”). Profile pages may be hosted by or accessible to social networking system 1002. Profile pages may also be hosted on third-party websites associated with a third-party server 1008. As an example and not by way of limitation, a profile page corresponding to a particular external webpage may be the particular external webpage and the profile page may correspond to a particular concept node 1104. Profile pages may be viewable by all or a selected subset of other users. As an example and not by way of limitation, a user node 1102 may have a corresponding user-profile page in which the corresponding user may add content, make declarations, or otherwise express himself or herself. As another example and not by way of limitation, a concept node 1104 may have a corresponding concept-profile page in which one or more users may add content, make declarations, or express themselves, particularly in relation to the concept corresponding to concept node 1104.

In particular embodiments, a concept node 1104 may represent a third-party webpage or resource hosted by a third-party system 1008. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 1006 to send to social networking system 1002 a message indicating the user's action. In response to the message, social networking system 1002 may create an edge (e.g., an “eat” edge) between a user node 1102 corresponding to the user and a concept node 1104 corresponding to the third-party webpage or resource and store edge 1106 in one or more data stores.

In particular embodiments, a pair of nodes in social graph 1100 may be connected to each other by one or more edges 1106. An edge 1106 connecting a pair of nodes may represent a relationship between the pair of nodes. In particular embodiments, an edge 1106 may include or represent one or more data objects or attributes corresponding to the relationship between a pair of nodes. As an example and not by way of limitation, a first user may indicate that a second user is a “friend” of the first user. In response to this indication, social networking system 1002 may send a “friend request” to the second user. If the second user confirms the “friend request,” social networking system 1002 may create an edge 1106 connecting the first user's user node 1102 to the second user's user node 1102 in social graph 1100 and store edge 1106 as social-graph information in one or more of data stores. In the example of FIG. 11, social graph 1100 includes an edge 1106 indicating a friend relation between user nodes 1102 of user “A” and user “B” and an edge indicating a friend relation between user nodes 1102 of user “C” and user “B.” Although this disclosure describes or illustrates particular edges 1106 with particular attributes connecting particular user nodes 1102, this disclosure contemplates any suitable edges 1106 with any suitable attributes connecting user nodes 1102. As an example and not by way of limitation, an edge 1106 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1100 by one or more edges 1106.

In particular embodiments, an edge 1106 between a user node 1102 and a concept node 1104 may represent a particular action or activity performed by a user associated with user node 1102 toward a concept associated with a concept node 1104. As an example and not by way of limitation, as illustrated in FIG. 11, a user may “like,” “attended,” “played,” “listened,” “cooked,” “worked at,” or “watched” a concept, each of which may correspond to an edge type or subtype. A concept-profile page corresponding to a concept node 1104 may include, for example, a selectable “check in” icon (such as, for example, a clickable “check in” icon) or a selectable “add to favorites” icon. Similarly, after a user clicks these icons, social networking system 1002 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 1002 may create a “listened” edge 1106 and a “used” edge (as illustrated in FIG. 11) between user nodes 1102 corresponding to the user and concept nodes 1104 corresponding to the song and application to indicate that the user listened to the song and used the application. Moreover, social networking system 1002 may create a “played” edge 1106 (as illustrated in FIG. 11) between concept nodes 1104 corresponding to the song and the application to indicate that the particular song was played by the particular application. In this case, “played” edge 1106 corresponds to an action performed by an external application (SPOTIFY) on an external audio file (the song “Imagine”). Although this disclosure describes particular edges 1106 with particular attributes connecting user nodes 1102 and concept nodes 1104, this disclosure contemplates any suitable edges 1106 with any suitable attributes connecting user nodes 1102 and concept nodes 1104. Moreover, although this disclosure describes edges between a user node 1102 and a concept node 1104 representing a single relationship, this disclosure contemplates edges between a user node 1102 and a concept node 1104 representing one or more relationships. As an example and not by way of limitation, an edge 1106 may represent both that a user likes and has used at a particular concept. Alternatively, another edge 1106 may represent each type of relationship (or multiples of a single relationship) between a user node 1102 and a concept node 1104 (as illustrated in FIG. 11 between user node 1102 for user “E” and concept node 1104 for “SPOTIFY”).

In particular embodiments, social networking system 1002 may create an edge 1106 between a user node 1102 and a concept node 1104 in social graph 1100. As an example and not by way of limitation, a user viewing a concept-profile page (such as, for example, by using a web browser or a special-purpose application hosted by the user's client system 1006) may indicate that he or she likes the concept represented by the concept node 1104 by clicking or selecting a “Like” icon, which may cause the user's client system 1006 to send to social networking system 1002 a message indicating the user's liking of the concept associated with the concept-profile page. In response to the message, social networking system 1002 may create an edge 1106 between user node 1102 associated with the user and concept node 1104, as illustrated by “like” edge 1106 between the user and concept node 1104. In particular embodiments, social networking system 1002 may store an edge 1106 in one or more data stores. In particular embodiments, an edge 1106 may be automatically formed by social networking system 1002 in response to a particular user action. As an example and not by way of limitation, if a first user uploads a picture, watches a movie, or listens to a song, an edge 1106 may be formed between user node 1102 corresponding to the first user and concept nodes 1104 corresponding to those concepts. Although this disclosure describes forming particular edges 1106 in particular manners, this disclosure contemplates forming any suitable edges 1106 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social networking system 1002). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 1002 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 1002) or RSVP (e.g., through social networking system 1002) to an event associated with the advertisement. In addition or as an alternative, an advertisement may include social-networking-system context directed to the user. As an example and not by way of limitation, an advertisement may display information about a friend of the user within social networking system 1002 who has taken an action associated with the subject matter of the advertisement.

In particular embodiments, social networking system 1002 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 1008 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 1002 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part based on a history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 1002 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 250%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 1002 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 1002 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 1002 may calculate a coefficient based on a user's actions. Social networking system 1002 may monitor such actions on the online social network, on a third-party system 1008, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 1002 may calculate a coefficient based on the user's actions with particular types of content. The content may be associated with the online social network, a third-party system 1008, or another suitable system. The content may include users, profile pages, posts, news stories, headlines, instant messages, chat room conversations, emails, advertisements, pictures, video, music, other suitable objects, or any combination thereof. Social networking system 1002 may analyze a user's actions to determine whether one or more of the actions indicate an affinity for subject matter, content, other users, and so forth. As an example and not by way of limitation, if a user may make frequently posts content related to “coffee” or variants thereof, social networking system 1002 may determine the user has a high coefficient with respect to the concept “coffee.” Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 1002 may calculate a coefficient based on the type of relationship between particular objects. Referencing the social graph 1100, social networking system 1002 may analyze the number and/or type of edges 1106 connecting particular user nodes 1102 and concept nodes 1104 when calculating a coefficient. As an example and not by way of limitation, user nodes 1102 that are connected by a spouse-type edge (representing that the two users are married) may be assigned a higher coefficient than user nodes 1102 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 1002 may determine that the user has a higher coefficient with respect to the first photo than the second photo because having a tagged-in-type relationship with content may be assigned a higher weight and/or rating than having a like-type relationship with content. In particular embodiments, social networking system 1002 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 1002 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 1100. As an example and not by way of limitation, social-graph entities that are closer in the social graph 1100 (i.e., fewer degrees of separation) may have a higher coefficient than entities that are further apart in the social graph 1100.

In particular embodiments, social networking system 1002 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 1006 of the user). A first user may be more interested in other users or concepts that are closer to the first user. As an example and not by way of limitation, if a user is one mile from an airport and two miles from a gas station, social networking system 1002 may determine that the user has a higher coefficient for the airport than the gas station based on the proximity of the airport to the user.

In particular embodiments, social networking system 1002 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 1002 may provide information that is relevant to user's interests and current circumstances, increasing the likelihood that they will find such information of interest. In particular embodiments, social networking system 1002 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 1002 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 1002 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 1008 (e.g., via an API or other communication channel), or from another suitable system. In response to the request, social networking system 1002 may calculate the coefficient (or access the coefficient information if it has previously been calculated and stored). In particular embodiments, social networking system 1002 may measure an affinity with respect to a particular process. Different processes (both internal and external to the online social network) may request a coefficient for a particular object or set of objects. Social networking system 1002 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed Aug. 8, 2006, U.S. patent application Ser. No. 12/977,027, filed Dec. 22, 2010, U.S. patent application Ser. No. 12/978,265, filed Dec. 23, 2010, and U.S. patent application Ser. No. 13/632,869, field Oct. 1, 2012, each of which is incorporated by reference in their entirety.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 1104 corresponding to a particular photo may have a privacy setting specifying that the photo may only be accessed by users tagged in the photo and their friends. In particular embodiments, privacy settings may allow users to opt in or opt out of having their actions logged by social networking system 1002 or shared with other systems (e.g., third-party system 1008). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 1008, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 1002 may send a request to the data store for the object. The request may identify the user associated with the request and may only be sent to the user (or a client system 1006 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
detecting, by at least one processor, event details from text in at least one electronic communication shared between a plurality of users of a communication application;
determining, by the at least one processor, that the event details from the text in the at least one electronic communication satisfy a minimum event detail threshold;
based on the determination that the event details satisfy the minimum event detail threshold, presenting for display an indication of an event to the plurality of users;
based on user interaction with the presented indication, creating a digital event; and
sending information regarding the created digital event to at least one of the plurality of users via the communication application.

2. The method of claim 1, wherein
detecting event details from the text in the at least one electronic communication between the plurality of users of the communication application comprises:
detecting a first event detail from first text in a first electronic communication between the plurality of users; and
detecting a second event detail from second text in a second electronic communication between the plurality of users;
presenting for display the indication comprises: presenting the indication of the event with regard to the first text; and
creating the digital event comprises: creating the digital event utilizing the first event detail and the second event detail.

3. The method of claim 1, wherein detecting event details from text in the at least one electronic communication shared between the plurality of users of the communication application further comprises:
identifying a time window based on one or more characteristics of the at least one electronic communication;
limiting the at least one electronic communication to a set of one or more electronic communications that fall within the time window; and
detecting event details by analyzing the set of one or more electronic communications that fall within the time window.

4. The method of claim 3, wherein the one or more characteristics of the at least one electronic communication comprises at least one of the following: an amount of time between electronic communications, a date of the at least one electronic communication, or a time of the at least one communication.

5. The method of claim 1, wherein the minimum event detail threshold comprises a number of detected event details corresponding to the created digital event, the number of detected event details being greater than one.

6. The method of claim 1, further comprising:
after creating the digital event, identifying one or more additional event details from one or more additional electronic communications between the plurality of users; and
modifying the digital event based on the one or more additional event details.

7. The method of claim 1, wherein the plurality of users are participating in a thread of electronic messages, and wherein the method further comprises: modifying the number of users participating in the thread of electronic messages based on the digital event.

8. The method of claim 7, wherein modifying the number of users participating in the thread of electronic messages based on the digital event comprises:
determining that at least one user of the plurality of users participating in the thread of electronic messages is not part of the digital event; and
removing the at least one user that is not part of the digital event from participating in the thread of electronic messages.

9. The method of claim 1, wherein creating the digital event comprises:
accessing a plurality of existing digital events created by users of an online social network;
comparing the detected event details to the plurality of existing digital events;
based on the comparison, identifying at least one existing digital event from the plurality of existing digital events created by users of the online social network that correspond to the detected event details; and
creating the digital event based, at least in part, on the identified at least one existing digital event from the plurality of existing digital events created by users of the online social network.

10. The method of claim 9, further comprising:
detecting a modification to the at least one existing digital event from the plurality of existing digital events created by users of the online social network; and
modifying the created digital event based on the modification to the at least one existing digital event from the plurality of events created by the users of the online social network.

11. A system comprising:
at least one processor; and
at least one non-transitory computer readable storage medium storing instructions that, when executed by the at least one processor, cause the system to:
detect event details from text in at least one electronic communication shared between a plurality of users of a communication application;
determine that the event details from the text in the at least one electronic communication satisfy a minimum event detail threshold;
based on the determination that the event details satisfy the minimum event detail threshold, present for display an indication of an event to the plurality of users;
based on user interaction with the presented indication, create a digital event; and
send information regarding the created digital event to at least one of the plurality of users via the communication application.

12. The system of claim 11, wherein
detecting event details from the text in the at least one electronic communication between the plurality of users of the communication application comprises:
detecting a first event detail from first text in a first electronic communication between the plurality of users; and
detecting a second event detail from second text in a second electronic communication between the plurality of users;
presenting for display the indication comprises: presenting the indication of the event with regard to the first text and the second text; and
creating the digital event comprises: creating the digital event utilizing the first event detail and the second event detail.

13. The system of claim 11, wherein detecting event details from text in the at least one electronic communication shared between the plurality of users of the communication application further comprises:
identifying a time window based on one or more characteristics of the at least one electronic communication;
limiting the at least one electronic communication to a set of one or more electronic communications that fall within the event communication time window; and
detecting event details by analyzing the set of one or more electronic communications that fall within the event communication time window.

14. The system of claim 11, further comprising instructions that, when executed by the at least one processor, cause the system to:
after creating the digital event, identify one or more additional event details from one or more additional electronic communications between the plurality of users; and
modify the digital event based on the one or more additional event details.

15. The system of claim 11, wherein creating the digital event comprises:
accessing a plurality of existing digital events created by users of an online social network;
comparing the detected event details to the plurality of existing digital events;
based on the comparison, identifying at least one existing digital event from the plurality of existing digital events created by users of the online social network that correspond to the detected event details; and
creating the digital event based on the identified at least one existing digital event from the plurality of existing digital events created by users of the online social network.

16. A non-transitory computer readable medium storing instructions thereon that, when executed by at least one processor, cause a computer system to:
detect event details from text in at least one electronic communication shared between a plurality of users of a communication application;
determine that the event details from the text in the at least one electronic communication satisfy a minimum event detail threshold;
based on the determination that the event details satisfy the minimum event detail threshold, present for display an indication of an event to the plurality of users;
based on user interaction with the presented indication, create a digital event; and
send information regarding the created digital event to at least one of the plurality of users via the communication application.

17. The non-transitory computer readable medium of claim 16, wherein
detecting event details from the text in the at least one electronic communication between the plurality of users of the communication application comprises:
detecting a first event detail from first text in a first electronic communication between the plurality of users; and
detecting a second event detail from second text in a second electronic communication between the plurality of users;
presenting for display the indication comprises: presenting an indication of the event with regard to the first text and the second text; and
creating the digital event comprises: creating a digital event utilizing the first event detail and the second event detail.

18. The non-transitory computer readable medium of claim 16, wherein detecting event details from the plurality of words in the at least one electronic communication further comprises:
identifying a time window based on one or more characteristics of the at least one electronic communication;
limiting the at least one electronic communication to a set of one or more electronic communications that fall within the time window; and
detecting event details by analyzing the set of one or more electronic communications that fall within the time window.

19. The non-transitory computer readable medium of claim 16, further comprising instructions that, when executed by the at least one processor, cause the computer system to:
after creating the digital event, identify one or more additional event details from one or more additional electronic communications between the plurality of users; and
modify the digital event based on the one or more additional event details.

20. The non-transitory computer readable medium of claim 16, wherein the plurality of users are participating in a thread of electronic communications, and wherein the non-transitory computer readable medium further comprises instructions that, when executed by the at least one processor, cause the computer system to modify the number of users participating in the thread of electronic communications based on the digital event.
